(19) United States
(12) Patent Application Publication
(10) Pub. No.: US 2024/0394477 A1
(43) Pub. Date: Nov. 28, 2024

(54) Constructing Prompt Information for Submission to a Language Model by Dynamically Selecting from Context Information

(71) Applicant: Microsoft Technology Licensing, LLC, Redmond, WA (US)

(72) Inventors: Sayan Dev PATHAK, Kirkland, WA (US); Harini KESAVAMOORTHY, Bellevue, WA (US); Zoltan ROMOCSA, Kenmore, WA (US); Christopher Hakan BASOGLU, Everett, WA (US); Girish Milind MAHAJAN, Redmond, WA (US); Salman Mohammad QUAZI, Mountain View, CA (US)

(73) Assignee: Microsoft Technology Licensing, LLC, Redmond, WA (US)

(21) Appl. No.: 18/211,573

(22) Filed: Jun. 19, 2023

Related U.S. Application Data
(60) Provisional application No. 63/468,195, filed on May 22, 2023.

(51) Int. Cl. G06F 40/30; G06F 40/284; G06F 40/40

(52) U.S. Cl. CPC G06F 40/30; G06F 40/284; G06F 40/40

(57) ABSTRACT

A technique for interacting with a machine-trained language model uses dynamic prompt management. The technique includes: receiving an input query; accessing a state data store that provides candidate context information; partitioning the candidate context information into plural parts; selecting targeted context information from the candidate context information by determining a semantic relevance of the input query to each of the plural parts by performing vector-based analysis; creating prompt information that includes the input query and the targeted context information; submitting the prompt information to the machine-trained language model; and receiving a response from the machine-trained language model based on the prompt information. The technique has the overall effect of reducing the number of content units submitted to the language model, which, in turn, reduces the amount of resources and time required by the language model to process the input query.

This application claims the benefit of U.S. Provisional Application No. 63/468,195 (the '195 Application), filed on May 22, 2023. The '195 Application is incorporated by reference herein in its entirety.

### BACKGROUND

The execution of a language model typically requires significant processing and memory resources. In view thereof, an application which uses a language model may be forced to throttle the number of user requests it accepts at any given time, so as not to exceed the resource capacity of its execution platform. To further address this issue, an application typically limits the size of the prompt that can be input to the language model. The prompt refers to input information that is fed to the language model at each dialogue turn, on the basis of which the language model generates a response. An application progressively increases the size of the prompt at each turn of a dialogue. This is because each prompt is constructed by appending the user's current query to the last-generated model response, which, in turn, is appended to the previous prompt. The current prompt therefore expresses the current query together with the most recent dialogue history (up to the maximum number of tokens that are permitted by the application).

An application which uses a language model may also exhibit substandard performance in some cases, independent of the above-described resource-related challenges. For instance, in some cases, the language model has difficulty in correctly interpreting the context expressed in the prompt. Further, the application may take a relatively long period of time to generate responses using the language model (e.g., several seconds). This delay in response may impede the natural flow of a conversation and/or may degrade the performance of the application in other environment-specific ways.

### SUMMARY

A technique is described herein for interacting with a machine-trained language model using dynamic prompt management. Over the course of a dialogue, the technique has the effect of reducing a number of content units submitted to the language model. A content unit refers to a unit of linguistic information, such as a word, phrase, fragment of a word, etc., and/or a unit of any other type of information (such as image information). The reduction in the number of content units allows an execution platform that runs the language model to efficiently process each input query. The efficiency is manifested in a reduction in resources and time required to process each input query. At the same time, the technique does not degrade the quality of the language model's responses, as the information that is submitted to the language model is chosen based on its assessed relevance to each input query.

A language model refers to a machine-trained model that is capable of processing language-based input information and, optionally, any other kind of input information (including video information, image information, audio information, etc.). As such, a language model can correspond to a multi-modal machine-trained model.

According to one illustrative aspect, the technique includes: receiving an input query; accessing a state data store that provides candidate context information; partitioning the candidate context information into plural parts; selecting targeted context information from the candidate context information by determining a semantic relevance of the input query to each of the plural parts by performing vector-based analysis; creating prompt information that includes the input query and the targeted context information; submitting the prompt information to the machine-trained language model, and receiving a response from the machine-trained language model based on the prompt information; and generating output information based on the response. The operation of selecting reduces a size of the prompt information by selecting a subset of the parts of the candidate context information that is less than all of the parts of the candidate context information, which reduces an amount of resources consumed by the language model in processing the prompt information, and reduces a latency at which the language model provides the response.

According to another illustrative aspect, the candidate context information includes a dialogue history that precedes the input query. More specifically, the dialogue history includes previous input queries submitted to the language model, and previous responses generated by the language model for the previous input queries.

According to another illustrative aspect, the candidate context information also includes knowledge information retrieved from at least one knowledge source other than the dialogue history.

According to another illustrative aspect, the technique further includes: assessing a complexity level associated with a task of processing the input query; and determining a size of the prompt information based on the complexity level.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a computing system that includes a prompt-managing component for dynamically generating an efficient prompt for submission to a language model.

FIG. 2 graphically represents how the prompt-managing component constructs a prompt by selecting from candidate context information.

FIG. 3 graphically represents the manner in which the prompt-managing component dynamically varies the size of an instance of prompt information over the course of a dialogue.

FIG. 4 shows rules-based logic for implementing the computing system of FIG. 1.

FIG. 5 shows machine-trained logic for implementing the computing system of FIG. 1.

FIG. 6 shows one implementation of a complexity-analyzing component, which is one part of the prompt-managing component of FIG. 1.

FIG. 7 shows one implementation of a dialogue history-selecting component, which is another part of the prompt-managing component of FIG. 1.

FIG. 8 shows one implementation of a knowledge-supplementing component, which is another part of the prompt-managing component of FIG. 1.

FIG. 9 shows one implementation of a compression component, which is another part of the prompt-managing component of FIG. 1.

FIG. 10 shows one implementation of a content unit substitution component, which is one part of the compression component of FIG. 9.

FIG. 11 shows one implementation of a deduplication component, which is another part of the prompt-managing component of FIG. 1.

FIG. 12 shows one implementation of a redundant information-identifying component, which is one part of the deduplication component of FIG. 11.

FIG. 13 shows one implementation of a data-structure reformatting component, which is another part of the deduplication component of FIG. 11.

FIG. 14 shows one implementation of the language model of FIG. 1.

FIG. 15 show a process that represents an overview of one manner of operation of the computing system of FIG. 1.

FIG. 16 shows a process that represents an overview of another manner of operation of the computing system of FIG. 1.

FIG. 17 shows computing equipment that, in some implementations, is used to implement the computing system of FIG. 1.

FIG. 18 shows an illustrative type of computing system that, in some implementations, is used to implement any aspect of the features shown in the foregoing drawings.

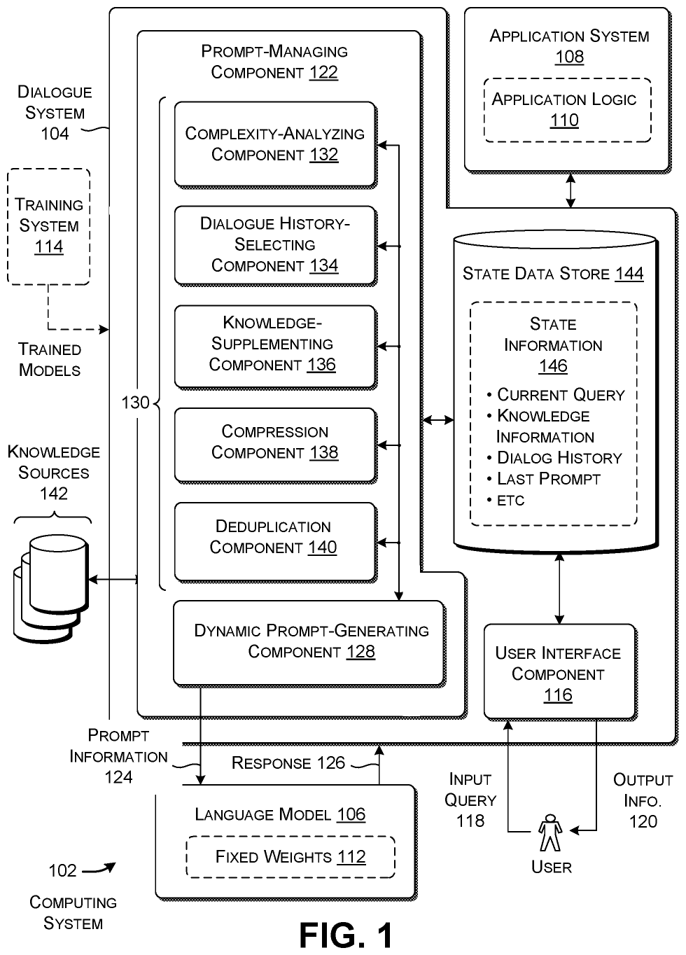

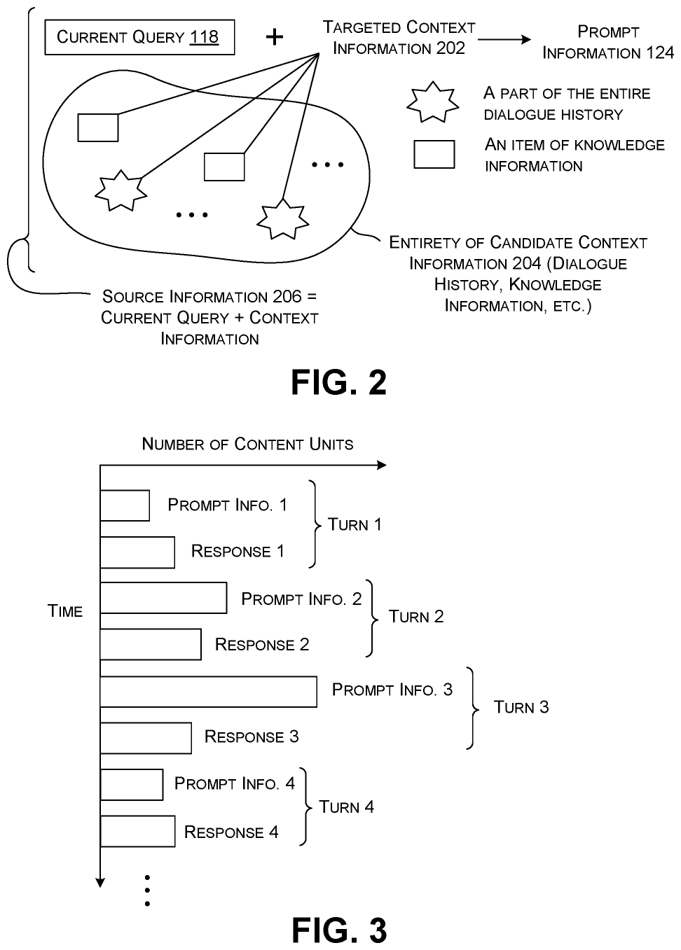

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

### A. Overview of the Computing System

This section provides an overview of a computing system 102 shown in FIG. 1. The computing system 102 includes a dialog system 104 which provides responses to a user's queries over one or more dialogue turns. The dialog system 104 performs this service in cooperation with a language model 106. This section provides an overview of the computing system 102. Sections B-G provide additional illustrative details regarding individual components of the computing system 102.

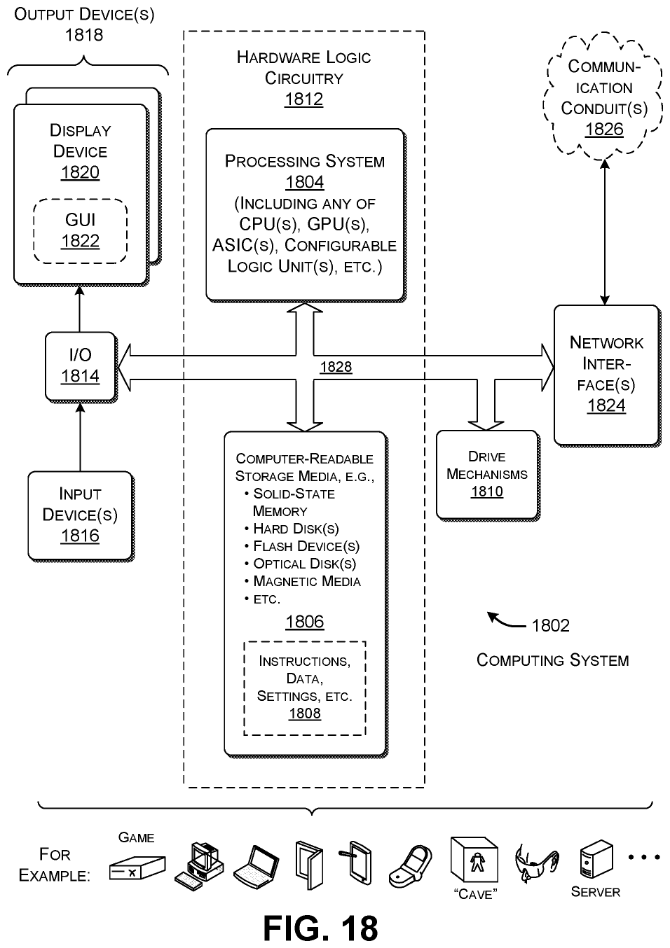

By way of terminology, as used herein, a “machine-trained model” refers to computer-implemented logic for executing a task using machine-trained weights that are produced in a training operation. A “weight” refers to any type of parameter value that is iteratively produced by the training operation. In some contexts, terms such as “component,” “module,” “engine,” and “tool” refer to parts of computer-based technology that perform respective functions. FIGS. 17 and 18, described below, provide examples of illustrative computing equipment for performing these functions.

In some implementations, the dialogue system 104 and the language model 106 are provided and maintained by a same entity. In other implementations, the dialogue system 104 and the language model 104 are provided by different respective entities.

The terms “content unit” and “token” refer to a unit of linguistic information (including a word, a part of a word, a phrase, etc.) and/or a unit of any other type of information (such as image information). The term “token” specifically refers to a unit of information processed by the language model 106 itself. For example, in some implementations, the language model 106 includes a tokenizer that breaks a received linguistic passage into a sequence of units referred to as tokens, and thereafter processes the tokens using a transformer-based neural network (e.g., as described in Section G). The term “content unit” is used to quantify information that is processed by the dialogue system 104. For example, the term “content unit” refers to a unit to information that is sent to the language model 106 for processing. Note that the above definitions are agnostic to where tokenization is formally performed in the computing system 102. The dialogue system 104, for instance, can perform tokenization instead of the language model 106. In any such case, the term “content unit” is used when discussing information prior to its processing by the language model 106. To simplify definitional matters, in one illustrative case, there is a one-to-one correspondence between a sequence of content units and a corresponding sequence of tokens processed by the language model 106, and each unit/token corresponds to an individual word.

An application system 108 uses the dialogue system 104 in the course of providing an overarching service. For example, one kind of application system performs a reservation function with the assistance of the dialogue system 104. Another kind of application performs a question-answering function with the assistance of the dialogue system 104. Another kind of application performs an online shopping function based on guidance provided by the dialogue system 104, and so on. FIG. 1 generally shows that the application system 108 includes application logic 110 for performing its native functions. For example, a reservation system includes a program for checking availability of an item (including a vehicle, an airline flight, a hotel room, etc.), a program for processing a user's payment, and so on.

In some implementations, the computing system 102 relies on an “off-the-shelf” language model 106 having given fixed weights 112, produced by others using a pre-training operation. A publicly-available transformer-based model for performing pattern completion is the BLOOM model available from HUGGING FACE, INC., of New York, New York, one version of which is Version 1.3 released on Jul. 6, 2022.

In some implementations, a pre-training system (not shown) trains the language model 106 with respect to one or more generic language-model tasks, unrelated to specific functions performed by the dialogue system. (Note that the developer typically receives the language model 106 after the pre-training has been performed by others.) In a first language-modeling task, for example, the pre-training system randomly masks tokens in a sequence of input tokens input to the language model 106. The pre-training system assesses an extent to which the language model 106 can successfully predict the identities of the masked tokens, and updates the weights 112 of the language model 106 accordingly. In a second language-modeling task, the pre-training system feeds two concatenated sentences to the language model 106, including a first sentence and a second sentence. The pre-training system then measures an extent to which the language model 106 can successfully predict whether the second sentence properly follows the first sentence (with reference to ground-truth information that indicates whether the second sentence properly follows the first sentence), and then updates the weights of the language model accordingly. Background on the general task of pre-training language models is provided in Devlin, et al., “BERT: Pre-training of Deep Bidirectional Transformers for Language Understanding,” arXiv, Cornell University, arXiv: 1810.04805v2 [cs.CL], May 24, 2019, 16 pages.

Once trained, the language model 106 operates as a pattern-completion engine. That is, the language model 106 autoregressively predicts the tokens that are most likely to follow an initial set of tokens. The language model 106 performs this function based on its ability to capture the statistical patterns exhibited by the training examples processed in the pre-training operation. Background information on the general topic of auto-regression in language models can be found at Brown, et al., “Language Models are Few-Shot Learners,” arXiv, Cornell University, arXiv: 2005.14165v4 [cs.CL], Jul. 22, 2020, 75 pages.

More specifically, the language model 106 performs auto-regression in the following manner. Assume that an initial sequence of text tokens ( . . . T_{N-3}, T_{N-2}, T_{N-1}, T_{N}) is input to the language model 106, with T_{N} being a last submitted text token. For instance, the initial sequence of text tokens corresponds to an instance of prompt information. The language model 106 maps the model-input information into output information that identifies a next text token (T_{N+1}) that is likely to follow the sequence of text tokens. The agent appends the generated token (T_{N+1}) to the end of the previous sequence of tokens, and then feeds the updated model-input information ( . . . T_{N-3}, T_{N-2}, T_{N-1}, T_{N}, T_{N+1}) to the language model. The agent continues this autoregressive process until the language model 106 generates a stop token. The agent interprets the stop token as an instruction to stop generating tokens in the above-described manner.

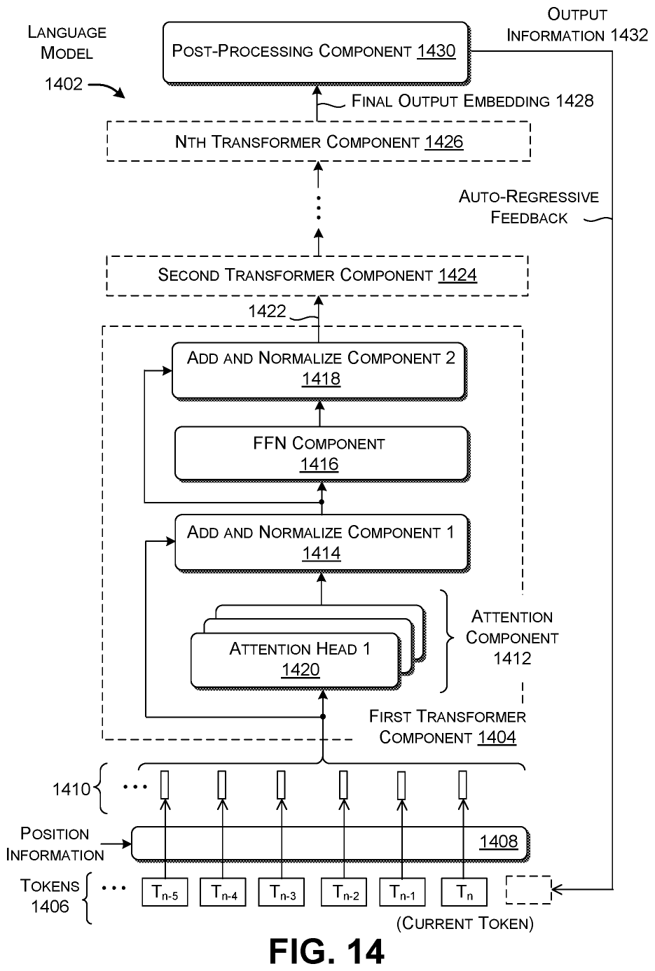

In some implementations, the language model 106 incorporates attention-based logic. Attention-based logic is functionality that assesses the relevance of each part of input information fed to the attention-based logic with respect to the interpretation of each other part of the input information (and with respect to the same part). More specifically, in some implementations, the language model 106 is implemented as a series of transformer blocks. Further details regarding this type of model are set forth below in Section G, in connection with FIG. 14. Other implementations of the language model 106 use other types of machine-trained models, including fully-connected feed-forward neural networks (FFNs), convolutional neural networks (CNNs), recurrent neural networks (RNNs), and so on, or any combination thereof.

In some implementations, the language model 106 processes only language-based content units provided to the language model 106. A language-based content unit corresponds to any unit of linguistic information, including a word, a part of a word, etc. In other implementations, the language model 106 is a multi-modal machine-trained model that is capable of processing any type, or combination of types, of content units. For example, in some implementations, the language model 106 processes input information that includes any combination of language-based content units, video-based content units, image-based content units, audio-based content units, etc. Here, a content unit corresponds to any part of a larger whole, such as, for case of an image content unit, a n×m pixel-portion of an image. To facilitate explanation, however, the following explanation presents examples in which the language model 106 processes language-based content units.

A training system 114 trains one or more other machine-trained models used by the dialogue system 104. Later sections will provide additional details regarding these other machine-trained models. At this juncture, note, however, that the weights 112 of the language model 106 are fixed. This means that the training system 114 need not fine-tune the weights 112 of the language model 106 itself when it trains the other machine-trained models (although, in other implementations, it can perform some retraining of the language model 106).

Now referring to the dialogue system 104 itself, a user interface component 116 provides an interface by which a user or other entity interacts with the dialogue system 104. In some cases, for example, the user interface component 116 receives an input query 118 from a user. The input query 118 includes one or more words that convey a question or other information to which the language model 106 is asked to respond. The user interface component 116 receives the input query in any input form, such as a text-based form, a voice-based form, etc. If received in a voice-based form, the user interface component 116 uses a speech-recognition system (not shown) to convert the input query to text-based form.

The dialogue system 104 generates output information 120 in response to the input query 118. In part, the output information 120 expresses or otherwise depends on a final response provided by the language model 106. The user interface component 116 delivers the output information 120 to the user in any form, such as a text-based form, a voice-based form, and so on.

A prompt-managing component 122 manages the generation of prompt information 124 for each turn of a dialogue session. As explained above, the prompt information 124 corresponds to input information that the dialogue system 104 feeds to the language model 106, and is composed of a sequence of content units (e.g., words). The language model 106 processes the prompt information 124 to generate a response 126, which is fed back into the prompt-managing component 122. More specifically, the prompt information 124 expresses the user's input query 118 together with targeted context information that expresses the context of the user's input query 118. As will be explained in greater detail below, the targeted context information includes content units selected from a dialogue history and/or content units selected from knowledge information retrieved from at least one knowledge source. The pool of information from which the targeted context information is selected is generally referred to below as candidate context information. (Although not shown, at the beginning of a dialogue session, the prompt-managing component 122 prepends a set of initial content units to the prompt information 124. This initial set of content units is commonly referred to as a seed prompt, and is generally used to inform the language model 106 of the task it is expected to perform.)

A dynamic prompt-generating component 128 operates as a control agent of the prompt-managing component 122. For instance, the dynamic prompt-generating component 128 coordinates interaction with different analysis components 130. The dynamic prompt-generating component 128 also assembles information provided by the separate analysis components 130 into the prompt information 124.

By way of overview, in creating the prompt information 124, the prompt-managing component 122 selects some context information in the candidate context information, but generally not the entirety of candidate context information. In addition, or alternatively, the prompt-managing component 122 selects information from the input query 118 when constructing the prompt information 124.

By performing targeted selection, for many dialogue turns, the dynamic prompt-generating component 128 reduces the number of content units in the instances of prompt information submitted to the language model 106, compared to the case of including the entirety of the candidate context information and the input query 118. At the same time, the dynamic prompt-generating component 128 operates in an intelligent manner by selecting context information that is most aptly suited to answering the input queries; therefore, the dynamic prompt-generating component 128 does not degrade the quality of the responses generated by the language model 106. Note, however, that the prompt-generating component 128 need not always eliminate content units; for instance, in other cases, the dynamic prompt-generating component 128 concludes that it is appropriate for the prompt information 124 to include a relatively large number of content units because the question being asked is complex and requires a relatively lengthy instance of prompt information to describe it. In other cases, the dynamic prompt-generating component 128 determines that it is appropriate to include all of the candidate context information at the beginning of a dialogue.

The prompt-managing component 122 has a number of technical merits. For instance, the prompt-managing component 122 reduces the amount of content units in the prompt information 124 over the course of a dialogue. It requires more time and resources for an execution platform to process lengthy instances of prompt information compared to shorter instances of prompt information. Hence, the prompt-managing component 122 has the overall effect of reducing the consumption of resources in an execution platform that implements the language model 106, as well as improving the latency-related performance of the computing system 102 as a whole. “Resources” here include processing resources, memory resources, communication resources, bandwidth, power, etc. More specifically, consider the case in which first prompt information has a first number of content units, and second prompt information has a second number of content units, the second number of content units being greater than the first number of content units. It requires more memory and processing resources (such as CPU resources) to process and store the second prompt information during processing, compared to the first prompt information. It further requires more networking resources and bus-related resources to transfer the second prompt information from one destination to another, compared to the first prompt information. Previous dialogue systems, by contrast, progressively grow the size of prompt information as a dialogue proceeds. In such a system, the execution platform that implements a language model therefore requires an increasing amount of resources to process each query in a dialogue.

As stated above, the reduction in content units achieved by the dialogue system 104 does not unduly degrade the quality of responses generated by the language model 106. This is because the prompt-managing component 122 intelligently selects the information items that are most aptly suited to answering each input query.

In certain cases, the prompt-managing component 122 also improves the quality of responses generated by the language model 106. This is because the prompt-managing component 122 eliminates or reduces the occurrence of extraneous information items that are not relevant to answering the question. This reduces the chances that irrelevant context information in the prompt information 124 will lead the language model 106 astray, causing it to generate errant responses.

Further, the prompt-managing component 122 also does not follow a practice of automatically purging older context information upon reaching a maximum number of content units. Rather, the prompt-managing component 122 intelligently selects from all parts of the candidate context information for each input query, without necessarily disfavoring older context items. In other implementations, however, one of more components of the prompt-managing component 122 can consider the age of a particular context item as one factor, among other factors, in determining whether the particular context item should be included in the prompt information 124 being composed.

As another merit, the dialogue system 104 is readily applicable to different applications without requiring significant (or any) modification to its basic architecture. This makes the dialogue system 104 flexible and scalable, and reduces the effort and cost associated with its maintenance. For instance, the dialogue system 104 can be readily modified in at least the following ways: (1) by adjusting the amount of content units that are used to compose the prompt information 124; and/or (2) by adjusting the criteria that is used to compose the prompt information 124. A developer may leverage this flexibility by promoting the retention of one kind of context information for one kind of application, and promoting the retention of another kind of context information for another kind of application. In some cases, an adaption to a new application environment requires only the modification of one or more parameter values that govern the operation of prompt-managing component 122. For instance, a developer can adjust one parameter value that determines an amount of content units to be used in constructing the prompt information 124. Alternatively, or in addition, a developer can adjust another parameter value that specifies a weight to be placed on a specified kind of context information in constructing the prompt information 124. For instance, a dialogue system used in conjunction with a shopping-related application can favorably weight terms in the candidate context information that pertain to product names and product attributes, while a navigation application can favorably weight terms that pertain to map-related entities.

Likewise, the dialogue system 104 flexibly adapts to different execution environments. For instance, the dialogue system 104 can adapt the way it constructs the prompt information 124 based on a complexity level set by a user or application provider, and/or based on the processing capabilities of the application system 108 and/or the execution platform that runs the language model 106.

The dialogue system 104 is effective in handling many different scenarios, examples of which are provided at the end of Section A. For instance, in some examples, the dialogue system 104 dynamically crafts prompt information 124 that reflects a user's meandering focus of search, without necessarily including content from previous dialogue turns that is not relevant to a current focus of interest. Alternatively, or in addition, the dialogue system 104 compresses source information from which the prompt information 124 is constructed, e.g., by picking salient terms from the source information and/or removing redundant information from the source information.

Now explaining one implementation of the dialogue system 104 in greater detail, the analysis components 130 include one or more of: a complexity-analyzing component 132, a dialogue history-selecting component 134, a knowledge-supplementing component 136, a compression component 138, and a deduplication component 140. The complexity-analyzing component 132 determines a complexity level to be assigned to each input query submitted in a dialogue session. Based thereon, the complexity-analyzing component 132 determines an appropriate number content units to include in the prompt information 124 when processing each input query. Section B provides further information regarding the operation of the complexity-analyzing component 132.

The dialogue history-selecting component 134 selects the parts of the dialogue history that are most relevant to the task of answering the input query 118, and the dynamic prompt-generating component 128 uses those parts to compose the prompt information 124. In many cases, the dialogue history-selecting component 134 will only select a portion of the entire dialogue history, not the entirety of the dialogue history. Section C provides further information regarding the operation of the dialogue history-selecting component 134.

The knowledge-supplementing component 136 retrieves knowledge information from one or more external knowledge sources 142. “External” in this context refers to the fact that some of the knowledge sources express information that is generated external to the dialogue system 104. One exemplary knowledge source corresponds to a dictionary or encyclopedia-type resource, such as the Wikipedia website. Another exemplary knowledge source corresponds to a repository of customer reviews. Another exemplary knowledge source corresponds to a repository that provides information regarding the user, such as a website or data store that provides a user profile. Another knowledge source represents any information available by conducting a search via a general-purpose search engine.

In any event, the knowledge information is made up of a plurality of knowledge items. The knowledge-supplementing component 136 chooses those knowledge items that are most relevant to the task of answering the user's input query 118. The dynamic prompt-generating component 128 uses that portion to compose the prompt information 124 for the current input query 118. Section D provides further information regarding the operation of the knowledge-supplementing component 136.

The compression component 138 selects concepts from the source information that are most representative of the source information. “Source information” refers to any of the input query 118 and/or the candidate context information (including the dialogue history and the knowledge information). For instance, the compression component 138 selects one or more keywords from the source information. Alternatively, or in addition, the compression component 138 selects one or more named entities from the source information. Alternatively, or in addition, the compression component 138 uses topic analysis to identify one or more topics that are pertinent to the source information. The compression component 138 has the effect of compressing the source information by using selected terms to describe it. (Note that other components of the prompt-managing component 122 also perform the function of compression, but in different respective ways.) The dynamic prompt-generating component 128 uses the selected terms to compose the prompt information 124 for the current input query 118. Alternatively, or in addition, the compression component 138 includes a content unit substitution component (not shown in FIG. 1) that replaces certain terms in the source information with abbreviations of those terms as a one-to-one mapped compressed representation. Section E provides further information regarding the operation of the compression component 138.

The deduplication component 140 identifies and removes redundant information from the source information, to further compress the source information. The deduplication component 140 performs this task by identifying a group of information items having embeddings within a prescribed distance of each other in vector space, and selecting a representative information item from the group, and/or using a data structure to express some of the source information in a way that reduces the amount of redundant information items contained therein. The dynamic prompt-generating component 128 uses portions of the compressed source information to compose the prompt information 124 for the current input query 118. Section F provides further information regarding the operation of the deduplication component 140.

A state data store 144 stores state information 146. The state information 146 describes various aspects of a current state of a dialogue between the user and the language model 106, as mediated by the dialogue system 104. For example, the state information 146 includes any of: a) a current input query 118; b) knowledge information identified by the knowledge-supplementing component 136, both in the current dialogue turn and prior dialogue turns; c) a current response (or responses) generated by the language model 106 in response to the current input query 118; d) dialogue history information regarding any previous turn of the dialogue, prior to the current dialogue turn in which the user has submitted the input query 118; and e) at least the last-submitted prompt information. In summary, the state information 146 describes the input query 118 together with the entirety of the candidate context information that may pertain to the input query 118. In other implementations, the candidate context information expressed in the state information 146 also includes other contextual factors, such as location information (identifying the location from which the user is conducting the dialogue session), user behavior information, and so on. Different implementations of the dialogue system 104 use different strategies to control how long each of the above kinds of information is retained.

FIG. 2 summarizes one principle of the operation of the prompt-managing component 122. FIG. 2 specifically indicates that the prompt information 124 includes content units (e.g., words or portions of words) expressed in the current query 118 and targeted context information 202. In some implementations, the prompt-managing component 122 selectively composes the targeted context information 202 from candidate context information 204 provided in the state data store 144. The candidate context information 204 includes at least the complete dialogue information (including all previous input queries and model responses produced by the language model 106) and all information retrieved by the knowledge-supplementing component 136 for the current dialogue turn and any previous dialogue turns. Note that the candidate context information 204 includes a first number of content units, and the targeted context information 202 includes a second number of content units. For many dialogue turns, the second number of content units is less than the first number of content units. Although not shown in FIG. 2, the prompt-managing component 122 can also select from parts of the input query 118, rather than including the complete input query 118 as given.

As used herein, “source information” 206 refers any of the input query 118 and/or the candidate context information 204. Another way to express the function of the prompt-managing component 122 is as a follows: the prompt-managing component 122 constructs the prompt information 124 by selectively compressing the source information 206.

FIG. 3 summarizes another principle of the operation of the prompt-managing component 122. A horizontal axis represents the number of content units in a user query or a response. A vertical axis represents time. As explained above, the prompt-managing component 122 dynamically composes each instance of prompt information by selecting only those parts of dialogue history and external knowledge information that are relevant to answering the current input query which pertains to a particular topic. (Other implementations can also take into consideration other factors when selecting information items, such as the presumed objective of the dialogue.) In addition, or alternatively, the prompt-managing component 122 selects part of the input query 118, rather than the entirety of the input query 118. In view of this behavior, unlike traditional language model solutions, the prompt-managing component 122 need not increase the size of the prompt information in an unvarying manner as a conversation advances. This improves the efficiency of the dialogue system 104 for the reasons stated above.

In the particular case of FIG. 3, assume that the user progressively builds on a particular line of questioning over the first three dialogue turns, but then effectively starts with a new line of inquiry pertaining to a new topic in the fourth dialogue turn. In response to this query behavior, the prompt-managing component 122 progressively increases the size of the instances of prompt information over the course of the first three dialogue turns, but then formulates a comparatively smaller instance of prompt information for the fourth dialogue turn. This fourth-turn behavior is performed because the prompt-managing component 122 determines that the information imparted by the first three dialogue turns is not relevant to the topic raised in the fourth dialogue turn, and therefore need not be expressed in the prompt information (at least in full). Although not shown, assume that the user returns to the topic of the first three dialogue turns at a later juncture of the conversation. In response, when constructing new prompt information for this dialogue turn, the prompt-managing component 122 selectively pulls content units generated in the first three dialogue turns of the conversation.

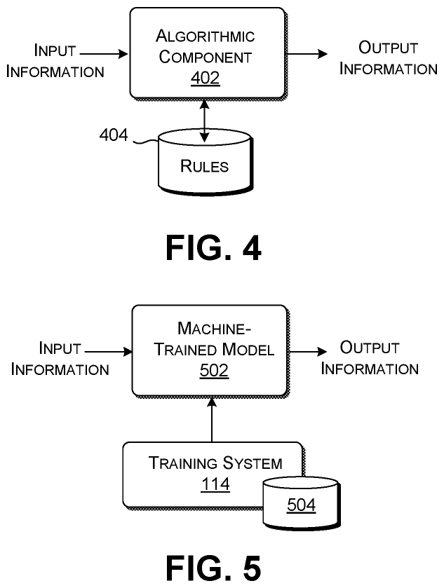

With reference to FIGS. 4 and 5, the computing system 102 relies on any type of functionality, or any combinations of different types of functionality, to implement the functions described above. For instance, FIG. 4 shows an example in which an algorithmic component 402 uses one or more rules provided in a data store 404 to map input information to output information. The rules can be expressed as discrete IF-THEN type rules and/or any other type(s) of rules. Alternatively, or in addition, the rules can be expressed as an algorithm, e.g., as a program that performs a subroutine. FIG. 5 shows an example in which a machine-trained model 502 maps input information to output information. The machine-trained model 502 includes weights produced by the training system 114 in a preliminary training operation. For instance, the training system 114 iteratively processes a collection of training examples in a data store 504, e.g., using stochastic gradient descent in combination with backpropagation. The training system 114 calculates error for each iteration of training using a loss function.

As stated above, the dialogue system 104 is effective in handling many different scenarios. The following are representative scenarios in which the dialogue system 104 improves the efficiency of the execution platform that runs the language model 106, and, in the process, improves the overall performance of the computing system 102.

Scenario A. The application system 108 hosts an e-commerce site. The user submits a user query that asks about a phone, upon which the language model 106 delivers a response. In the next dialogue turn, the user submits an input query directed to the topic of battery health. In the next dialogue turn, the user submits an input query directed to details of the phone's camera. The user's focus thereby shifts over the first three turns as the user explores different topics of interest. If the user's interest continues to meander, the content of prior user queries and language model responses may not be fully relevant to a current input query. To address this problem, the dialogue system 104 selects relevant parts of the candidate context information that have the greatest bearing on the user's current focus of interest.

Scenario B. The application system 108 includes functionality that enables a user to interact with an online resource that links related information items in a graph. In a particular dialogue turn, the user submits an input query that incorporates information pulled from the graph. Or the knowledge-supplementing component 136 extracts information from the graph. Assume that the content pulled from the graph includes numerous key-value pairs in which, for at least one key, the same key appears plural times. For example, a portion of calendar-related content includes redundant labels for attributes such as name, id, email, location, etc. The deduplication component 140 addresses this cases by eliminating or reducing the amount of redundant labels in the extracted information. Without this provision, the information extracted from the graph would have wasted a significant portion of the allocated token budget for the current dialogue turn, and may have even exceeded the allocated budget.

Scenario C. The user queries, language model responses, and/or external knowledge information include unique entities with names, some of which may be lengthy. The compression component 138 addresses this issue by replacing these names with placeholder abbreviations.

Scenario D. The application system 108 hosts a video-conferencing application. Assume that a user conducts an hour-long meeting in which approximately 8,000 words are spoken, as expressed in approximately 800 sentences. Assume that a user poses a user query that references the transcript of the meeting. For example, the user submits an input query that asks “Who is the project leader in charge of Project Delta in Atlanta, as was discussed in the meeting <meeting transcript>.” The dialogue system 104 addresses this situation by identifying at least one part of the transcript that is relevant to the input query, e.g., by identifying those sentences in the transcript that appear to be most closely related to the concepts of “project leader,” “Project Delta,” “Atlanta,” etc. expressed in the input query. The dialogue system 104 can perform the same function with respect to any referenced document.

### B. Illustrative Complexity-Analyzing Component

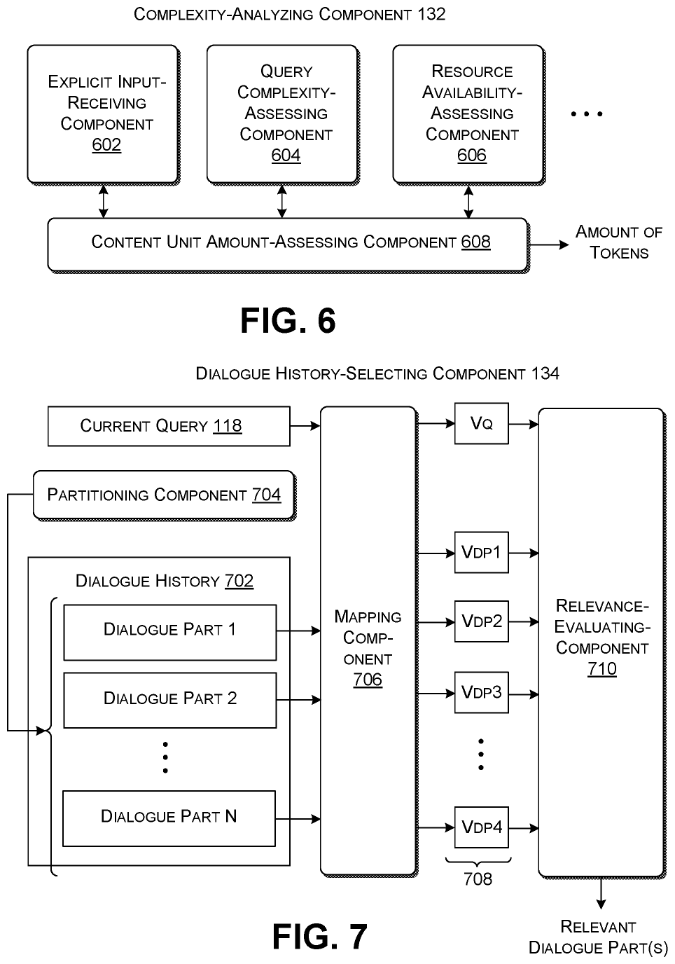

FIG. 6 shows one implementation of the complexity-analyzing component 132. The complexity-analyzing component 132 performs the task of determining a complexity level associated with the user's input query 118. The complexity level of the input query 118 generally reflects the complexity of the task of interpreting the input query 118 by the language model 106. The complexity level of the input query 118 also has a bearing on the complexity of the prompt information 124 to be formulated by the prompt-managing component 122 to express the input query 118. Generally, the number of content units required to express a query increases with the complexity of the input query. Overall, the complexity-analyzing component 132 allows the dialogue system 104 to flexibly adapt to different application and execution environments.

The complexity-analyzing component 132 relies on one more components and associated techniques to perform its task, including an explicit input-receiving component 602, a query complexity-assessing component 604, and a resource availability-assessing component 606. A content unit amount-assessing component 608 coordinates interaction with the above-identified components. Further, the content unit amount-assessing component 608 determines, based on the assessed complexity level, a maximum number of content units to include in the prompt information 124 for the current dialogue turn. In other cases, the content unit amount-assessing component 608 sets a scaling factor that operates to reduce (or expand) the amount content units in the prompt information 124, without setting a maximum number of content units. Alternatively, or in addition, each of the other components (134, 136, 138, and 140) of the prompt-managing component 122 uses the assessed complexity level to determine how aggressively it should compress source information (corresponding to the input query 118 and/or the candidate context information); this implementation need not define an explicit maximum number of content units. In general, the content unit amount-assessing component 608 is said to provide output results that govern the size of the prompt information 124 to be formulated.

The explicit input-receiving component 602 receives an explicit instruction from a user or other entity (such as a developer or application provider) which specifies a complexity level. For example, the instructions specifies any of the levels of low, medium, or high (which may be relabeled, for instance, as “economy,” “standard,” and “premium”). In other examples, the instructions specify a complexity level within a continuous range of complexity levels. In one implementation, a user chooses the complexity level for an entire dialogue (or multiple dialogues) via a configuration interface provided by the computing system 102. Thereafter, the prompt-managing component 122 constrains the size of each instance of prompt information it generates based on the complexity level. In some applications, different complexity levels are associated with different costs.

Alternatively, or in addition, the user specifies the complexity level for each dialogue turn in a dialogue. The explicit input-receiving component 602 allows the user to enter per-query instructions in different ways. In one example, the explicit input-receiving component 602 receives an input signal in response to the user interacting with a user interface control provided by the dialogue system 104, or the user entering an input command in spoken form. In another case, the explicit input-receiving component 602 receives a user's instruction specified in the input query 118 itself. In this last mentioned case, in addition to controlling the size of the prompt information 124, the complexity level specified in the input query 118 instructs the language model 106 to generate a response having a particular level of detail.

The query complexity-assessing component 604 uses rules-based logic and/or a machine-trained model and/or other functionality to map the input query 118 to a complexity level. The rules-based logic uses one or more rules to determine the complexity level based on one or factors. These factors include any of combination of: a) the length of the input query 118; b) the number of clauses in the input query 118; c) the number of distinct named entities (e.g., products, places, or people) specified in the input query 118; d) the complexity of the logical relations expressed in the input query 118, and so on. Other factors depend on the overall complexity of the dialogue session in which the input query 118 appears. For example, other factors reflect the complexity level of the subject about which the user appears to be inquiring, over one or more dialogue turns. For example, consider a first user who wishes to know when a plane will depart from a particular airport to a particular destination, as opposed to a second user who is asking for the least expensive flight to a particular destination, given plural stated preferences. The first user's subject is less complex than the second user's topic. In part, this is because the first user's subject has fewer variables than the second user's subject, and the first user's subject requires less context to answer compared to the second user's subject.

In those cases in which the query complexity-assessing component 604 is implemented as a machine-trained model, the machine-trained model maps the input query 118 to an embedding, and then maps the embedding to a classification result. The machine-trained model can rely on any type of neural network to perform this task, including a feed-forward neural network, a convolutional neural network, a transformer-based neural network, and so on. The training system 114 trains such a machine-trained model using a corpus of training examples, each of which specifies an illustrative input query coupled with a ground-truth complexity level. The training system 114 attempts to minimize the difference between its predictions and the ground-truth labels.

The resource availability-assessing component 606 receives an input signal that indicates the current processing capacity of the execution platform that runs the language model 106. The processing capacity depends on one or more factors, including any combination of: a) the number of queued input requests; b) the amount of available processing resources; c) the amount of available memory resources, etc. In addition, or alternatively, the resource availability-assessing component 606 receives an input signal that indicates the current processing capacity of the application system 108 that uses the dialogue system 104. The resource availability-assessing component 606 uses a rules-based system and/or a machine-trained model and/or other functionality to map these factors into a complexity level. Here, the complexity level does not make an assessment of the conceptual complexity of the input query 118 per se, but an amount of resources that can be devoted to processing the input query 118.

The content unit amount-assessing component 608 consults environment-specific rules to determine a final complexity level based on the individual complexity levels specified by the above-identified components (602, 604, 606). In one case, the content unit amount-assessing component 608 selects the lowest of the complexity levels specified by the above-identified components (602, 604, 606). In another case, the content unit amount-assessing component 608 computes the final complexity level as a weighted combination of the complexity levels specified by the above-identified components (602, 604, 606), or as a machine-trained transformation of the complexity levels specified by the above-identified components, etc. In some implementations, the content unit amount-assessing component 608 then uses an environment-specific lookup table, machine-trained model, etc. to map the final complexity level to a number of content units to be used in composing the prompt information 124. The prompt-managing component 122 uses the number of content units specified by the complexity-analyzing component 132 to govern an amount of the candidate content information that is selected for incorporation into the prompt information. In other words, the prompt-managing component 122 uses the number of content units to determine how aggressively it is to compress the source information from which the prompt information 124 is constructed.

### C. Illustrative Dialogue History-Selecting Component

FIG. 7 shows one implementation of the dialogue history-selecting component 134. The dialogue history-selecting component 134 performs the task of selecting the dialogue parts in a dialogue history 702 that are most relevant to the input query 118. For some dialogue turns, this has the effect of reducing the size of the prompt information 124, which, in turn, contributes to the efficiency-related effects set forth above. The dialogue history-selecting component 134 includes a partitioning component 704 that partitions the dialogue history 702 into parts having a particular scope depending on one or more factors. The scope determines the size of each part. In one implementation, the partitioning component 704 treats each user query in a dialogue as a distinct part and each response in the dialogue as a distinct part. In another implementation, the partitioning component 704 treats each paragraph or each sentence or each distinct clause or each key-value pair in each input query and each response as a distinct part. For example, a part may correspond to a portion of an input query or a response. In another case, the partitioning component 704 dynamically chooses the scope of the parts for each dialogue turn based on one or more factors, including any of the complexity of the query (as determined by the query complexity-assessing component 604), an explicit user instruction, etc. A part is made up of one or more content units. For example, a sentence-level part is composed of a sequence of words in a sentence, each of which may be considered a content unit.

The partitioning component 704 performs its “chunking” operation in response to an environment-specific triggering event. In some implementations, for example, the partitioning component 704 performs its operation upon the introduction of any new information item, such as a new input query, response, or information item. The partition established thereby remains in place for subsequent dialogue turns. In other cases, the partitioning component 704 re-performs the partitioning operation for all or some of the candidate context information upon each dialogue turn. A new partitioning may be appropriate depending on the nature of a question being posed in a current dialogue turn.

A mapping component 706 maps the input query into a query embedding (e.g., a distributed vector VQ), and maps each dialogue part into a dialogue part embedding (e.g., a distributed vector VDP1 for the first dialogue part). Together, the mapping component 706 provides a set of embeddings 708. A distributed vector is a vector that distributes its information over its d dimensions, as opposed, for instance, to a one-hot vector which allocates a particular concept to each dimension. The proximity of two vectors in vector space specifies the degree to which these two vectors describe similar concepts. The mapping component 706 can use any neural network to perform the above-described mapping, such as the language model 106 itself (described in greater detail below in Section G). In other cases, the mapping component 706 performs the mapping using a feed-forward neural network, a convolutional neural network, and so on.

A relevance-evaluating component 710 determines the proximity of the query embedding to each dialogue-part embedding. The relevance-evaluating component 710 can use any metric to perform this assessing, such as cosine similarity, inner product, Euclidean distance, etc. The relevance-evaluating component 710 then selects zero, one, or more dialogue parts that satisfy a prescribed environment-specific relevance test. In one implementation, for example, the relevance-evaluating component 710 selects the N dialogue parts that are closest to the current input query 118, in which the proximity of each of the parts to the input query 118 satisfies an environment-specific threshold value. The dynamic prompt-generating component 128 then selectively includes these dialogue parts in the prompt information 124 it generates. In summary, the analysis performed by the mapping component 708 and the relevance-evaluating component 710 is said to be vector-based because it relies on comparisons of vectors in a vector space.

### D. Illustrative Knowledge-Supplementing Component

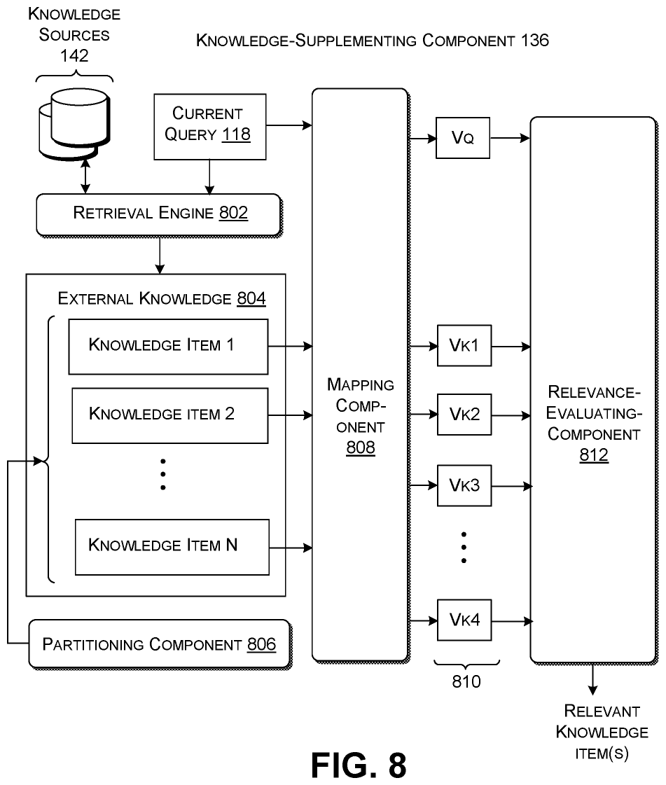

FIG. 8 shows one implementation of the knowledge-supplementing component 136. The knowledge-supplementing component 136 uses a retrieval engine 802 to retrieve knowledge information 804 from the knowledge sources 142. The knowledge-supplementing component 136 then selects parts of the knowledge information 804 for use in the prompt information 124. For some dialogue turns, this has the effect of reducing the amount of knowledge information imparted by the prompt information 124, which, in turn, contributes to the efficiency-related effects set forth above.

As to the first phase, the retrieval engine 802 is configured to initiate a retrieval operation based on different environment-specific triggering events. In one example, the retrieval engine 802 performs a retrieval operation for each query submitted by a user. For instance, upon submission of a new input query 118, the compression component 138 (described below) identifies keywords, named entities, and/or topics in the input query 116 and/or in the candidate context information. In response, the retrieval engine 108 performs a search to find supplemental information pertaining to the identified concepts, which are subsequently added to the candidate context information.

In another example, the retrieval engine 802 uses rules-based logic and/or a machine-trained model and/or other functionality to determine whether to perform the retrieval operation for the current input query 118. For instance, in some cases, the retrieval engine 802 performs the retrieval operation when the input query 118 contains a named entity, and/or the input query 118 specifies a particular topic.

Alternatively, or in addition, the retrieval engine 802 performs a retrieval operation upon making a preliminary determination that no other dialogue part or existing knowledge item is sufficiently relevant to the input query 118, as assessed using an environment-specific threshold value.

The retrieval engine 802 assesses relevance of an instance of knowledge information to the input query 118 using the vector-based analysis specified above in Section C (e.g., by mapping the instance of knowledge information and the input query 118 into two distributed vectors, and then assessing the distance between the two vectors in vector space). The retrieval engine 802 also uses environment-specific rules to determine the knowledge source(s) from which the knowledge information 804 is to be retrieved. For example, in those cases in which the input query 118 is soliciting advice regarding a product, the retrieval engine 802 consults a repository of customer reviews to retrieve the knowledge information. In some implementations, the retrieval engine 802 uses an application programming interface (API) to interact with the knowledge sources 142.

The knowledge information 804 is composed of multiple knowledge items. More specifically, the knowledge information 804 can include information retrieved in response to the current input query 118 and/or one or more previous input queries and/or in response to other triggering events. The knowledge-supplementing component 136 uses a partitioning component 806 to determine the scope of the individual knowledge items based on any of the factors described above in Section C. For example, the partitioning component 806 treats separate sentences or separate paragraphs, etc. as individual knowledge items. A mapping component 808 maps the input query 118 and each knowledge item into a respective embedding, to provide a set of embeddings 810. The mapping component 808 is implemented in any of the ways specified above in Section C. A relevance-evaluating component 812 selects zero, one, or more knowledge items based on any of the considerations specified above in Section C. For example, the relevance-evaluating component 812 selects N knowledge items that are closest to the current input query 118 or which satisfy any other environment-specific relevance test. The closeness of a knowledge item to the input query 118 can be assessed in any manner described above, e.g., by expressing the knowledge item and the input query 118 as two distributed vectors, and assessing the distance between the two vectors using cosine similarity or any other distance metric. After choosing the knowledge items, the dynamic prompt-generating component 128 selectively includes the chosen knowledge items in the prompt information 124 it generates.

### E. Illustrative Compression Component

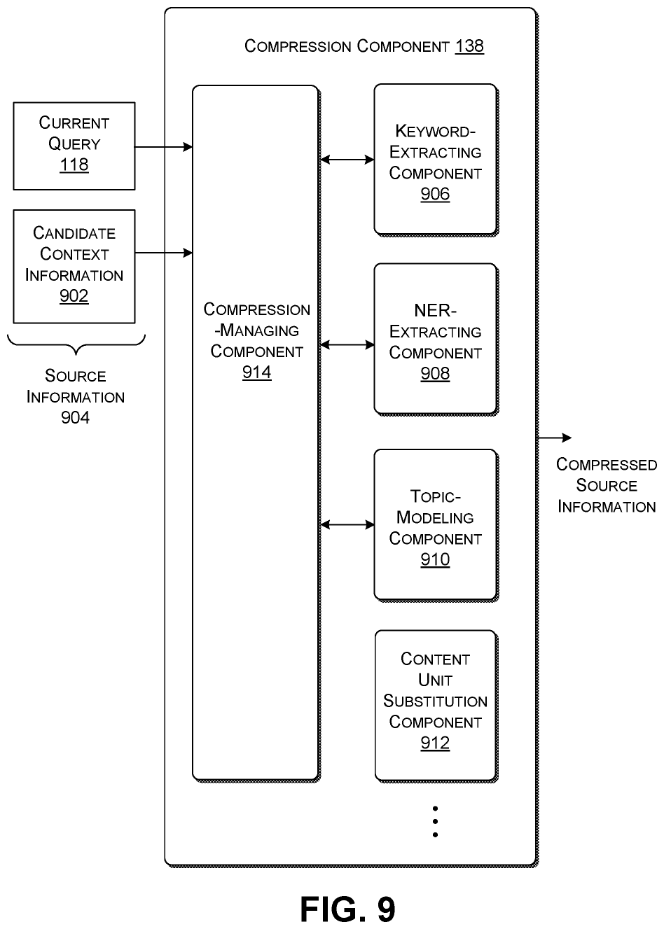

FIG. 9 shows one implementation of the compression component 138. The compression component 138 has the effect of reducing the number of content units in a more inclusive collection of content units, which, in turn, contributes to the efficiency-related benefits set forth above. In some cases, the compression component 138 compresses the content in the candidate context information 902, including the dialogue history and/or the knowledge information retrieved by the knowledge-supplementing component 136. Alternatively, or in addition, the compression component 138 compresses the content of the user input query 118. For shorthand, the content that the compression component 138 operates on is referred to as “source information” 904 herein. That is, the source information 904 refers to the input query 118, the candidate context information 902, etc., or any combination thereof. The compression component 138 maps the source information 904 to compressed source information.

The compression component 138 uses different components and associated techniques to perform different types of compression. Generally, each of the techniques provides a reduced-sized representation of the source information that preserves at least some semantic content of the source information in an original form. The reduced-sized representation of the source information is included in the prompt information 124 in lieu of the source information in its original form.

The components of the compression component 128 include a keyword-extracting component 906, a NER-extracting component 908 (in which “NER” is acronym for named entity recognition), a topic-modeling component 910, and a content unit substitution component 912. A compression-managing component 914 uses rules-based logic and/or a machine-trained logic and/or other functionality to determine when to invoke the individual compression components (906, 908, 910, and 912). In one case, once the compression component 138 is invoked, the compression-managing component 914 invokes all of the individual compression components (906, 908, 910, 912), which can then operate in parallel.

More specifically, in some cases, the dialogue history-selecting component 134 and knowledge-supplementing component 136 perform a first level of relatively coarse compression. The compression component 138 then performs a more detailed level of compression. In other cases, the compression component 138 is performed first, and the concepts extracted by this component 138 are used to trigger the operation of the knowledge-supplementing component 136. In still other cases, the prompt-managing component 122 applies the compression component 138 in place of the operation of the dialogue history-selecting component 134 and/or the knowledge-supplementing component 136. Alternatively, or in addition, the prompt-managing component 122 invokes the compression component 138 when a specified prompt-size constraint level is below a prescribed environment-specific threshold value, which necessitates special measures to make judicious use of content units. Still other strategies for invoking the knowledge-supplementing component 136 are possible.

The keyword-extracting component 906 uses any rules-based logic (e.g., any algorithm) or machine-trained model to detect prominent keywords or named entities associated with the source information 904. For example, the keyword-extracting component 906 can identify prominent words in the source information 904 using Term Frequency-Inverse Document Frequency (TF-IDF) or the TextRank algorithm. Alternatively, or in addition, the keyword-extracting component uses any type of machine-trained model, such as a classifier-type neural network, to identify keywords in the source information 904.

Likewise, the NER-extracting component 908 uses any rules-based logic (e.g., any algorithm) and/or machine-trained model to identify named entities associated with the source information 904. For instance, in one implementation, the NER-extracting component 909 uses a Conditional Random Fields (CFR) classifier to identify entity mentions within a stream of text content units. In another implementation, the NER-extracting component 908 uses any type of neural network to identify named entities. For example, a transformer-based encoder maps a sequence of text content units into a corresponding sequence of hidden-state embeddings. A post-processing classifier neural network then maps the hidden-state embeddings to probability information. The probability information specifies whether each content unit in the sequence of content units is part of an entity mention. In some implementations, the post-processing classifier neural network includes a machine-trained linear neural network followed by a Softmax operation (e.g., a normalized exponential function).

The topic-modeling component 910 can likewise uses various rules-based logic and/or machine-trained models to extract topics associated with the source information 904, including Latent Dirichlet Allocation (LDA), Non-negative Matrix Factorization (NMF), etc. Background information on the general subject of neural network technology that performs topic-extraction and summarization can be found at: Zhao, et al., “Topic Modelling Meets Deep Neural Networks: A Survey,” arXiv, Cornell University, arXiv: 2103.00498v1 [cs.LG], Feb. 28, 2021, 8 pages; and Dong, Yue, “A Survey on Neural Network-Based Summarization Methods,” arXiv, Cornell University, arXiv: 1804.04589v1 [cs.CL], Mar. 19, 2018, 16 pages.

In some implementations, the compression component 138 also weights the relevance of selected terms (keywords, named entities, topics, etc.) based on one or more weighting factors, and uses those weights factors in determining which terms are to be included in the prompt information 124. For example, the compression component 138 determines an extent to which a selected term is relevant to user interest information, e.g., as specified in a user profile. In some implementations, the compression component 138 makes this determination by performing a lexical and/or semantic comparison of the selected term and the user interest information. In some cases, the compression component 138 selects the K top-ranked terms. By favorably weighting a selected term, the compression component 138 promotes this term over other terms that are not similarly weighted, and increases the likelihood that the selected term will be included in the top K information items.

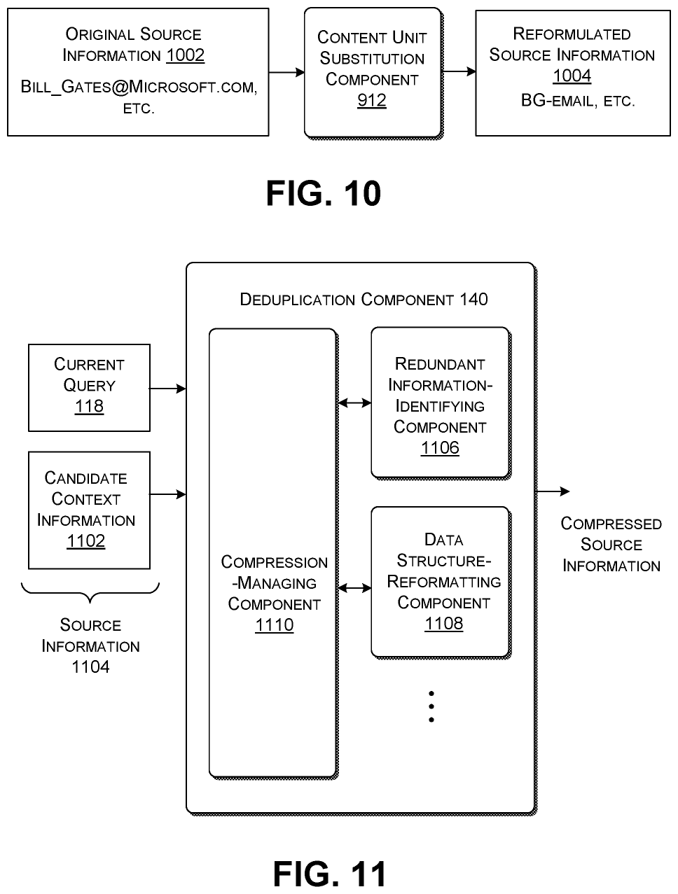

FIG. 10 summarizes the operation of the content unit substitution component 912. The content unit substitution component 912 applies one or more conversion rules to map certain strings in the source information 1002 to abbreviated strings in reformatted source information 1004. The conversion rules specify the kind of text strings to be abbreviated, and the manner in which they are to be abbreviated. Some conversion rules are implemented as a mapping lookup table. For example, assume that original source information 1002 includes the string “Bill_Gates@microsoft.com.” The content unit substitution component 912 consistently replaces all occurrences of “Bill Gates” (or the like) with “BG”. Consistent therewith, the content unit substitution component 912 replaces the above Email address for Bill Gates with the shortened string “BG-email.” In another example, assume that the original source information 1002 includes the GUID “F9168C5E-CEB2-4faa-B6BF-329BF39FA1E4.” The content unit substitution component 912 abbreviates this code to “F916.” The language model 106 is trained to look for patterns in text, so it will likely correctly interpret the meaning of the abbreviated strings based on the meaning imparted by the abbreviation and its surrounding context.

The content unit substitution component 912 performs a complementary restoration operation upon receiving a response from the language model 106 that includes one or more of its previously-defined abbreviations. For example, assume that the language model 106 delivers a response 126 that contains a string that mirrors an abbreviation expressed in the prompt information 124. The content unit substitution component 912 addresses this case by mapping the abbreviation back to its original form, e.g., by mapping “BG-email” back to “Bill_Gates@microsoft.com.”

### F. Illustrative Deduplication Component

FIG. 11 shows one implementation of the deduplication component 140. The deduplication component 140 performs another aspect of compression by identifying and removing (or reducing) redundant information in the input query 118 and/or the candidate context information 1102 (which, in turn, corresponds to the dialogue history and/or the external knowledge information). This information is again referred to herein as “source information” 1104. A part of the source information 1104 is referred to herein as an information item. The deduplication component 140 maps the source information 1104 to compressed source information. Overall, the deduplication component reduces the amount of information imparted by the prompt information 124, which, in turn, contributes to the efficiency-related effects set forth above.

A redundant information-identifying component 1106 identifies a group of information items in the source information 1104 that are considered as conveying the same concept, or closely-related concepts. The redundant information-identifying component 1106 then selects at least one representative member of the group for inclusion in the prompt information 124. In other words, this member represents the group as a whole in lieu of the entire group. For example, the redundant information-identifying component 1106 selects the member of the group that is most similar to the input query 118, e.g., as assessed by performed a vector-based comparison.

In some implementations, the redundant information-identifying component 1106 identifies a qualifying group of information items by using a mapping component (as explained in Section C), e.g., by using a neural network to map the information items to respective embeddings in a vector space. The redundant information-identifying component 1106 then determines if there is at least one group that has at least two embeddings within a radius of predetermined size. The redundant information-identifying component 1106 then selects one or more representative embeddings (and corresponding information items) from each such group.

In some implementations, the redundant information-identifying component 1106 chooses the radius of a candidate grouping based on the sparsity of embeddings in the vector space. In some implementations, the redundant information-identifying component 1106 generally uses a smaller radius for a densely-populated vector space compared to a more sparsely populated vector space. In some implementations, the redundant information-identifying component 1106 computes the density of a candidate cluster of embeddings by generating the cluster's mean diameter. Here, the radius of the cluster is also defined by its mean diameter.

In some implementations, the redundant information-identifying component 1106 uses a mahalanobis distance measure, a Kullback-Leibler (KL) divergence measure, etc. to identify one or more qualifying clusters, and to assess the characteristics of those clusters. The mahalanobis distance measure assesses the difference between a point and a distribution, and the KL divergence measure assesses the difference between two probability distributions. For example, in some implementations, the redundant information-identifying component 1106 computes the distance between two embeddings, associated with two information items, using either the Mahalanobis distance or a KL divergence measure. The redundant information-identifying component 1106 concludes that the two information items are in the same cluster if the computed measure satisfies a prescribed environment-specific threshold value. Alternatively, or in addition, the information-identifying component 1106 uses any non-parametric approach(es) to identify one or more qualifying clusters, and to assess the characteristics of those clusters. One such non-parametric approach uses k-nearest neighborhood analysis.

Different implementations use the redundant information-identifying component 1106 in different respective ways. In some implementations, the redundant information-identifying component 1106 first finds an information item in the source information that is closest to the user's current input query 118, e.g., as determined by performing the kind of vector-based analysis described in Section C. The redundant information-identifying component 1106 then determines whether the closest information item is a member of a cluster having redundant (or closely related) information items. If so, the redundant information-identifying component 1106 chooses a representative member of the group, such the information item that is closest to the input query 118. To a find a second information item that is relevant to the input query, the redundant information-identifying component 1106 repeats the above analysis, with the exception that the information items in the first-mentioned cluster are now excluded from the viable information items. That is, the redundant information-identifying component 1106 finds the information item that is closest to the user's current input query 118, excluding the information items in first-mentioned cluster. The redundant information-identifying component 1106 then determines whether the newly-identified closest information item is a member of a cluster having redundant information items. If so, the redundant information-identifying component 1106 chooses a representative member of the group. The redundant information-identifying component 1106 can repeat this operation M times to select M information items. By virtue of the behavior described above, the prompt-managing component 122 ensures that the M information items convey different facts that are relevant to the input query 118, rather than restatements of a single fact. The redundant information-identifying component 1106 can achieve the same effect by first partitioning the space of the source information into distinct clusters, and then choosing M representative information items that are most relevant to the input query 118 from the M distinct clusters.

Alternatively, or in addition, the redundant information-identifying component 1106: (1) examines the entire source information without reference to the input query; (2) identifies redundant clusters; and (3) replaces the redundant clusters with representative information items. The redundant information-identifying component 1106 may perform this function on a periodic basis or in response to any type of triggering event.

Alternatively, or in addition, the redundant information-identifying component 1106 is triggered to perform its function any time a new information item is committed to the state data store 144. The redundant information-identifying component 1106 ensures that the new information item is not the same or closely related to a pre-existing information item. If this is the case, the redundant information-identifying component 1106 again chooses a single representative information item for the concept under consideration, which could correspond to the new information item or the pre-existing information item. Still other strategies for using the redundant information-identifying component 1106 are possible.

A data structure-reformatting component 1108 modifies the format of at least part of the source information 1104 to reduce the redundant information contained therein. For example, consider the example in which the original source information 1104 describes a group of objects by specifying, for each object, the category (ies) to which it belongs. Further assume that two or more objects share the same category (ies). The data structure-generating component 1108 reformats this source information so that the shared category (ies) are specified only once for the two or more objects, rather than repeating this information for each these objects.

A compression-managing component 1110 determines when to invoke the redundant information-identifying component 1106 and the data structure-generating component 1108. In some implementations, the compression-managing component 1110 invokes these two components (1106, 1108) for every dialogue turn. In other implementations, the compression-managing component 1110 invokes the two components (1106, 1108) when operating under a restrictive token budget, and/or when the compression-managing component 1110 detects the inclusion of redundant information in the source information, to which the redundant information-identifying component 1106 and the data structure-reformatting component 1108 may be gainfully applied.

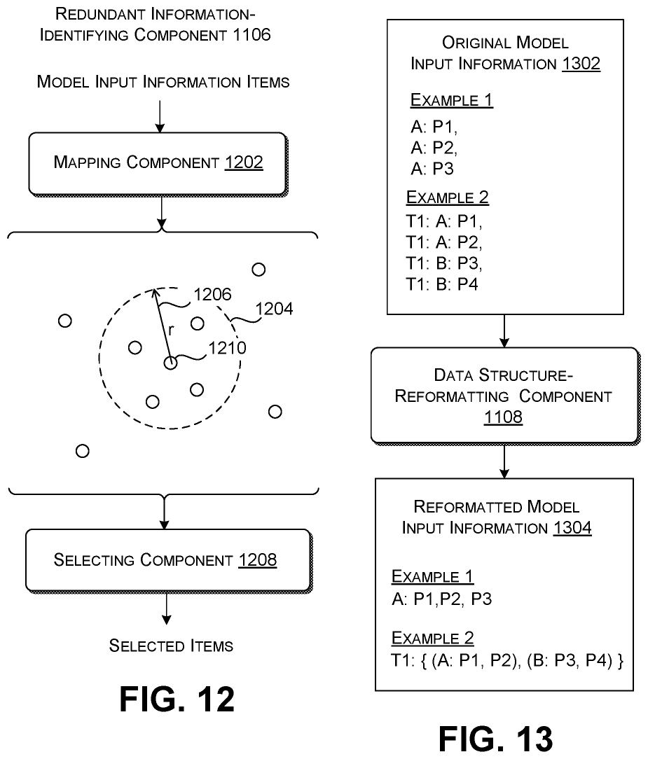

FIG. 12 shows one example of the operation of the redundant information-identifying component 1106. A mapping component 1202 maps a plurality of information items in the source information into respective embeddings. Assume that five of those embeddings lie in a cluster 1204 defined by a radius 1206. The selecting component 1208 selects a representative member from this cluster 1204, which thereafter represents the cluster 1204 as a whole. In one scenario, the redundant information-identifying component 1106 initiates its operations when the user submits an input query 118. The mapping component 1202 maps the input query 118 to an embedding 1210. In some implementations, the selecting component 1208 chooses the embedding in the cluster 1204 that is closest to the embedding 1210.

FIG. 13 shows the operation of the data structure-reformatting component 1108. In a first example, an instance of original source information 1302 identifies three information items (P1, P2, and P3) of type “A”. The original source information 1302 specifically duplicates the label “A” for all three of the information items. The data structure-reformatting component 1108 produces reformatted source information 1304 in which the redundant label “A” only appears once, accompanying by any environment-specific notation that conveys that the label applies to all three of the information items (P1, P2, and P3).

In a second example, the original source information 1302 identifies four information items (P1, P2, P3, and P4) of type “T1”. As a next level, the original source information 1302 identifies two information items (P1, P2) associated with category “A,” and two information items (P3, P4) associated with category “B.” The original information items are individually annotated with the labels that apply to the respective information items. The data structure-reformatting component 1108 again produces reformatted source information 1304 in which the redundant labels only appears once. In this example, the content unit count has been reduced from 12 to 7 (not counting the separator characters). In this case, the data structure-reformatting component 1108 reduces redundant content using a hierarchical tree structure.

Among its many uses, the data structure-reformatting component 1108 is helpful in reducing redundant information in content referenced by the input query 118. For example, assume that the input query 118 references calendar content having redundant calendar-related labels. The data structure-reformatting component 1108 is effective in reducing the occurrence of this redundant information.

### G. Illustrative Language Model

FIG. 14 shows one implementation of a language model 1402, which can be used as the language model 106 of FIG. 1. The language model 1402 is composed, in part, of a pipeline of transformer components, including a first transformer component 1404. FIG. 14 provides details regarding one way to implement the first transformer component 1404. Although not specifically illustrated, other transformer components of the language model 1402 have the same architecture and perform the same functions as the first transformer component 1404 (but are governed by separate sets of weights).

The language model 1402 commences with the receipt of the model-input information, e.g., corresponding to the prompt information 124. The model-input information is expressed as a series of linguistic tokens 1406. As previously explained, a “token” or “text token” refers to a unit of text having any granularity, such as an individual word, a word fragment produced by byte pair encoding (BPE), a character n-gram, a word fragment identified by the WordPiece algorithm or SentencePiece algorithm, etc. To facilitate explanation, assume that each token corresponds to a complete word.

Next, an embedding component 1408 maps the sequence of tokens 1406 into respective embedding vectors. For example, the embedding component 1408 produces one-hot vectors that describe the tokens, and then uses a machine-trained linear transformation to map the one-hot vectors into the embedding vectors. The embedding component 1408 then adds position information to the respective embedding vectors, to produce position-supplemented embedded vectors 1410. The position information added to each embedding vector describes the embedding vector's position in the sequence of embedding vectors.

The first transformer component 1404 operates on the position-supplemented embedding vectors 1410. In some implementations, the first transformer component 1404 includes, in order, an attention component 1412, a first add-and-normalize component 1414, a feed-forward neural network (FFN) component 1416, and a second add-and-normalize component 1418.

The attention component 1412 performs attention analysis using the following equation:

$$attn ( Q , K , V ) = Softmax ( \frac{{QK}^{T}}{\sqrt{d}} ) V . \qquad ( 1 )$$

The attention component 1412 produces query information Q by multiplying the position-supplemented embedded vectors 1410 (or, in some applications, just a last position-supplemented embedding vector associated with a last-received token) by a query weighting matrix W^{Q}. Similarly, the attention component 1412 produces key information K and value information V by multiplying the position-supplemented embedding vectors by a key weighting matrix W^{K} and a value weighting matrix W^{V}, respectively. To execute Equation (1), the attention component 1412 takes the dot product of Q with the transpose of K, and then divides the dot product by a scaling factor \sqrt{d}, to produce a scaled result The symbol d represents the dimensionality of Q and K. The attention component 1412 takes the Softmax (normalized exponential function) of the scaled result, and then multiplies the result of the Softmax operation by V, to produce attention output information. More generally stated, the attention component 1412 determines how much emphasis should be placed on parts of the input information when interpreting other parts of the input information. In some cases, the attention component 1412 is said to perform masked attention insofar as the attention component 1412 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 9 pages.

Note that FIG. 14 shows that the attention component 1412 is composed of plural attention heads, including a representative attention head 1420. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 1412 concatenates the output results of the attention component's separate attention heads, and then multiplies the results of this concatenation by another weight matrix W^{O}.

The add-and-normalize component 1414 includes a residual connection that combines (e.g., sums) input information fed to the attention component 1412 with the output information generated by the attention component 1412. The add-and-normalize component 1414 then normalizes the output information generated by the residual connection, e.g., by normalizing values in the output information based on the mean and standard deviation of those values. The other add-and-normalize component 1418 performs the same functions as the first-mentioned add-and-normalize component 1414. The FFN component 1416 transforms input information to output information using a feed-forward neural network having any number of layers.

The first transformer component 1404 produces an output embedding 1422. A series of other transformer components (1424, . . . , 1426) perform the same functions as the first transformer component 1404, each operating on an output embedding produced by its immediately preceding transformer component. Each transformer component uses its own level-specific set of machine-trained weights. The final transformer component 1426 in the language model 1402 produces a final output embedding 1428.

A post-processing component 1430 performs post-processing operations on the final output embedding 1428, to produce the final output information 1432. In one case, for instance, the post-processing component 1430 performs a machine-trained linear transformation on the final output embedding 1428, and processes the result of this transformation using a Softmax component (not shown). The post-processing component 1430 may optionally use the beam search method to decode the output of the Softmax component.

In some implementations, the language model 1402 operates in an auto-regressive manner. To operate in this way, the post-processing component 1430 uses the Softmax operation to predict a next token (or, in some cases, a set of the most probable next tokens). The language model 1402 then appends the next token to the end of the sequence of input tokens 1406, to provide an updated sequence of tokens. In a next pass, the language model 1402 processes the updated sequence of tokens to generate a next output token. The language model 1402 repeats the above process until it generates a specified stop token.

Note that the language model 106 shown in FIG. 14 corresponds to a decoder-only implementation of a machine-trained language model. In other examples, the language model 106 encompasses any combination of encoding, decoding, and/or any other functions. For example, in other cases, the language model 106 uses a decoder model that receives encoded information from a separate encoder model. In some implementations, both the encoder model and the decoder model include respective chains of transformer components and/or other type of attention-based logic.

### H. Illustrative Processes

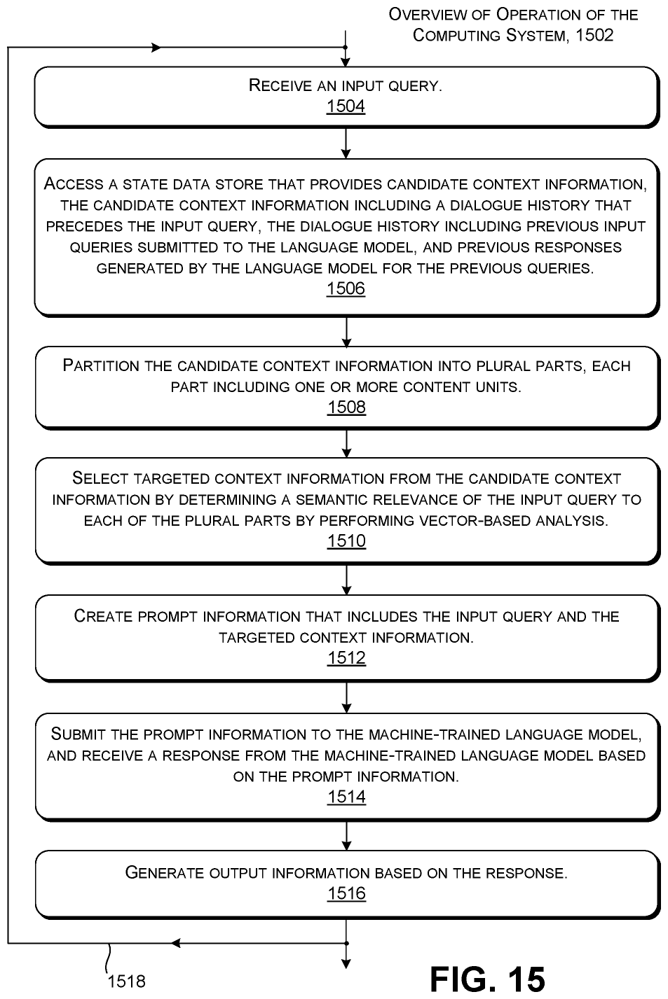

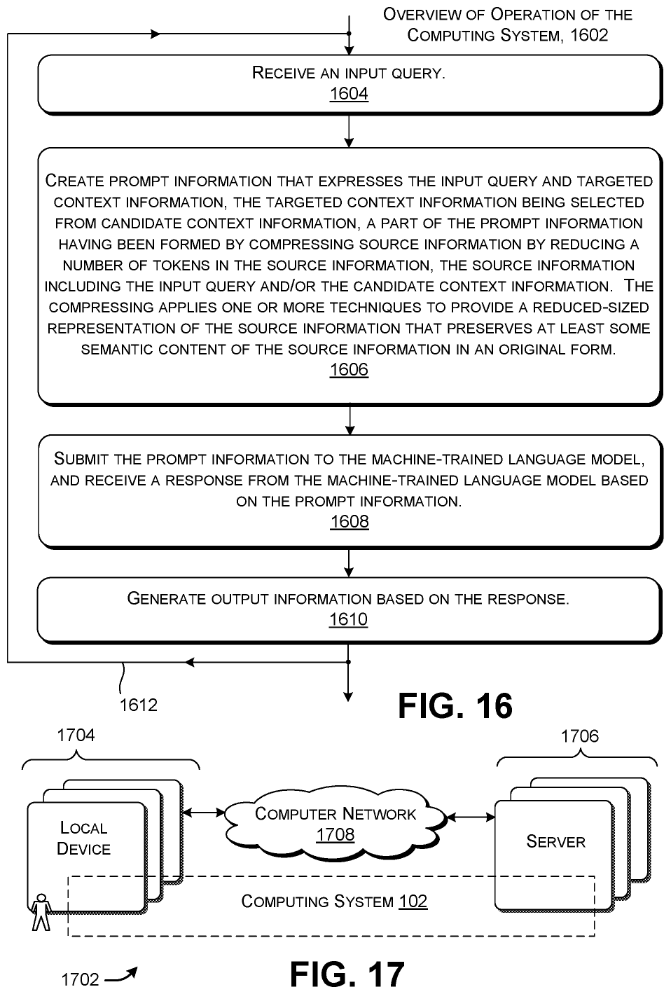

FIGS. 15 and 16 together show two processes (1502, 1602) that represent an overview of one manner of operation of the dialogue system 104 of FIG. 1. Each of the processes (1502, 1602) is expressed as a series of operations performed in a particular order. But the order of these operations is merely representative, and the operations are capable of being varied in other implementations. Further, any two or more operations described below can be performed in a parallel manner. In one implementation, the blocks shown in the processes (1502, 1602) that pertain to processing-related functions are implemented by the computing equipment described in connection with FIGS. 17 and 18.

More specifically, FIG. 15 shows a process for interacting with a machine-trained language model (e.g., the language model 106). In block 1504, the dialogue system 104 receives an input query (e.g., the input query 118). In block 1506, the dialogue system 104 accesses a state data store (e.g., the state data store 144) that provides candidate context information (e.g., the candidate context information 104). The candidate context information includes a dialogue history that precedes the input query. The dialogue history, in turn, includes previous input queries submitted to the language model, and previous responses generated by the language model for the previous input queries. In block 1508, the dialogue system 104 partitions the candidate context information into plural parts, each part including one or more content units. In block 1510, the dialogue system 104 selects targeted context information (e.g., the targeted context information 202) from the candidate context information by determining a semantic relevance of the input query to each of the plural parts by performing vector-based analysis. In block 1512, the dialogue system 104 creates prompt information (e.g., the prompt information 124) that includes the input query and the targeted context information. In block 1514, the dialogue system 104 submits the prompt information to the machine-trained language model, and receives a response (e.g., the response 126) from the machine-trained language model based on the prompt information. The operation of selecting (in block 1510) reduces a size of the prompt information by selecting a subset of the parts of the candidate context information that is less than all of the parts of the candidate context information. This reduces an amount of resources consumed by the language model in processing the prompt information, and reduces a latency at which the language model provides the response. In block 1516, the dialogue system 104 generates output information (e.g., output information 120) based on the response. Loop 1518 indicates that the above-described operations are repeated for each turn of a dialogue.

FIG. 16 shows another process 1602 for interacting with a machine-trained language model (e.g., the language model 106). In block 1604, the dialogue system 104 receives an input query (e.g., the input query 118). In block 1606, the dialogue system 104 creates prompt information (e.g., the prompt information 124) that expresses the input query and targeted context information (e.g., the targeted context information 202), the targeted context information being selected from candidate context information (e.g., the candidate context information 202). Further, a part of the prompt information is formed by compressing source information by reducing a number of content units in the source information, the source information including the input query and/or the candidate context information. More specifically, the compressing applies one or more techniques to provide a reduced-sized representation of the source information that preserves at least some semantic content of the source information in an original form. In block 1608, the dialogue system submits the prompt information to the machine-trained language model, and receives a response (e.g., the response 126) from the machine-trained language model based on the prompt information. In block 1610, the dialogue system 104 generates output information (e.g., the output information 120) based on the response. An execution platform that implements the machine-trained language model delivers the response in an amount of time that depends on a number of content units in the prompt information, and consumes an amount of resources that depends on the number of content units in the prompt information. The operation of compressing reduces a number of content units in the prompt information, which reduces an amount of resources consumed by the language model in processing the prompt information, and reduces a latency at which the language model provides the response. The loop 1612 indicates that the operations of receiving, compressing, creating, submitting, and generating are repeated for each turn of a dialogue.

### I. Illustrative Computing Functionality

FIG. 17 shows computing equipment 1702 that, in some implementations, is used to implement the computing system 102 of FIG. 1. The computing equipment 1702 includes a set of local devices 1704 coupled to a set of servers 1706 via a computer network 1708. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1708 is implemented as a local area network, a wide area network (e.g., the Internet), one or more point-to-point links, or any combination thereof.

The dashed-line box in FIG. 17 indicates that the functionality of the computing system 102 is capable of being spread across the local devices 1704 and/or the servers 1706 in any manner. For instance, in some cases, each local device, or a group of affiliated local devices, implements the entirety the computing system 102. In other implementations, the servers 1706 implement the entirety of the computing system 102. Here, an individual user interacts with the servers 1706 via a browser application or other local functionality provided by a local device. In other implementations, the functions of the computing system 102 are distributed between each local device and the server 1706. For example, in one case, the servers 1706 provide an execution platform that implement the language model 106, and each local device implements the remainder of the functions shown in FIG. 1.

FIG. 18 shows a computing system 1802 that, in some implementations, is used to implement any aspect of the mechanisms set forth in the above-described figures. For instance, in some implementations, the type of computing system 1802 shown in FIG. 18 is used to implement any local computing device or any server shown in FIG. 17. Further, the type of computing system 1802 shown in FIG. 18 is used to implement any of the dialogue system 104, the language model 106, the application system 108, etc. In all cases, the computing system 1802 represents a physical and tangible processing mechanism.

The computing system 1802 includes a processing system 1804 including one or more processors. The processor(s) include one or more Central Processing Units (CPUs), and/or one or more Graphics Processing Units (GPUs), and/or one or more Application Specific Integrated Circuits (ASICs), and/or one or more Neural Processing Units (NPUs), and/or one or more Tensor Processing Units (TPUs), etc. More generally, any processor corresponds to a general-purpose processing unit or an application-specific processor unit.

The computing system 1802 also includes computer-readable storage media 1806, corresponding to one or more computer-readable media hardware units. The computer-readable storage media 1806 retains any kind of information 1808, such as machine-readable instructions, settings, model weights, and/or other data. In some implementations, the computer-readable storage media 1806 includes one or more solid-state devices, one or more magnetic hard disks, one or more optical disks, magnetic tape, etc. Any instance of the computer-readable storage media 1806 uses any technology for storing and retrieving information. Further, any instance of the computer-readable storage media 1806 represents a fixed or removable unit of the computing system 1802. Further, any instance of the computer-readable storage media 1806 provides volatile and/or non-volatile retention of information.

More generally, any of the storage resources described herein, or any combination of the storage resources, is to be regarded as a computer-readable medium. In many cases, a computer-readable medium represents some form of physical and tangible entity. The term computer-readable medium also encompasses propagated signals, e.g., transmitted or received via a physical conduit and/or air or other wireless medium. However, the specific term “computer-readable storage medium” or “storage device” expressly excludes propagated signals per se in transit, while including all other forms of computer-readable media; a computer-readable storage medium or storage device is “non-transitory” in this regard.

The computing system 1802 utilizes any instance of the computer-readable storage media 1806 in different ways. For example, in some implementations, any instance of the computer-readable storage media 1806 represents a hardware memory unit (such as random access memory (RAM)) for storing information during execution of a program by the computing system 1802, and/or a hardware storage unit (such as a hard disk) for retaining/archiving information on a more permanent basis. In the latter case, the computing system 1802 also includes one or more drive mechanisms 1810 (such as a hard drive mechanism) for storing and retrieving information from an instance of the computer-readable storage media 1806.

In some implementations, the computing system 1802 performs any of the functions described above when the processing system 1804 executes computer-readable instructions stored in any instance of the computer-readable storage media 1806. For instance, in some implementations, the computing system 1802 carries out computer-readable instructions to perform each block of the processes described in with reference to FIGS. 15 and 16. FIG. 18 generally indicates that hardware logic circuitry 1812 includes any combination of the processing system 1804 and the computer-readable storage media 1806.

In addition, or alternatively, the processing system 1804 includes one or more other configurable logic units that perform operations using a collection of logic gates. For instance, in some implementations, the processing system 1804 includes a fixed configuration of hardware logic gates, e.g., that are created and set at the time of manufacture, and thereafter unalterable. In addition, or alternatively, the processing system 1804 includes a collection of programmable hardware logic gates that are set to perform different application-specific tasks. The latter category of devices includes Programmable Array Logic Devices (PALs), Generic Array Logic Devices (GALs), Complex Programmable Logic Devices (CPLDs), Field-Programmable Gate Arrays (FPGAs), etc. In these implementations, the processing system 1804 effectively incorporates a storage device that stores computer-readable instructions, insofar as the configurable logic units are configured to execute the instructions and therefore embody or store these instructions.

In some cases (e.g., in the case in which the computing system 1802 represents a user computing device), the computing system 1802 also includes an input/output interface 1814 for receiving various inputs (via input devices 1816), and for providing various outputs (via output devices 1818). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1820 and an associated graphical user interface presentation (GUI) 1822. The display device 1820 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1802 also includes one or more network interfaces 1824 for exchanging data with other devices via one or more communication conduits 1826. One or more communication buses 1828 communicatively couple the above-described units together.

The communication conduit(s) 1826 is implemented in any manner, e.g., by a local area computer network, a wide area computer network (e.g., the Internet), point-to-point connections, or any combination thereof. The communication conduit(s) 1826 include any combination of hardwired links, wireless links, routers, gateway functionality, name servers, etc., governed by any protocol or combination of protocols.

FIG. 18 shows the computing system 1802 as being composed of a discrete collection of separate units. In some cases, the collection of units corresponds to discrete hardware units provided in a computing device chassis having any form factor. FIG. 18 shows illustrative form factors in its bottom portion. In other cases, the computing system 1802 includes a hardware logic unit that integrates the functions of two or more of the units shown in FIG. 18. For instance, in some implementations, the computing system 1802 includes a system on a chip (SoC or SOC), corresponding to an integrated circuit that combines the functions of two or more of the units shown in FIG. 18.

The following summary provides a set of illustrative examples of the technology set forth herein.

(A1) According to one aspect, a method (e.g., the process 1502) is described for interacting with a machine-trained language model (e.g., the language model 106). The method includes: receiving (e.g., in block 1504) an input query (e.g., the input query 118); and accessing (e.g., in block 1506) a state data store (e.g., the state data store 144) that provides candidate context information (e.g., the candidate context information 204). The candidate context information includes a dialogue history that precedes the input query, the dialogue history including previous input queries submitted to the language model, and previous responses generated by the language model for the previous input queries. The method further includes: partitioning (e.g., in block 1508) the candidate context information into plural parts, each part including one or more content units; selecting (e.g., in block 1510) targeted context information (e.g., the targeted context information 202) from the candidate context information by determining a semantic relevance of the input query to each of the plural parts by performing vector-based analysis; creating (e.g., in block 1512) prompt information (e.g., the prompt information 124) that includes the input query and the targeted context information; submitting (e.g., in block 1514) the prompt information to the machine-trained language model, and receiving a response (e.g., the response 126) from the machine-trained language model based on the prompt information. The selecting reduces a size of the prompt information by selecting a subset of the parts of the candidate context information that is less than all of the parts of the candidate context information, which reduces an amount of resources consumed by the language model in processing the prompt information, and reduces a latency at which the language model provides the response. The method further includes generating output information (e.g., the output information 120) based on the response. The operations of receiving, accessing, partitioning, selecting, creating, submitting, and generating are repeated for each turn of a dialogue, as indicated by the loop 1518 in FIG. 15.

According to one illustrative characteristic, the method decreases a number of content units sent to the language model. Decreasing the number of content units reduces work that the language model is requested to perform. As a further consequence, decreasing the number of content units reduces expenditure of resources by the language model, and improves latency at which the language model delivers the response. This is because the language model consumes resources and time to process each content unit. The method also improves the quality of the language model response in some cases.

(A2) According to some implementations of the method of A1, each content unit is a word or a part of a word.

(A3) According to some implementations of the methods of A1 or A2, the machine-trained language model is a transformer-based model that includes attention logic for assessing relevance to be given to a part of input information fed to the attention logic when interpreting each part of the input information.

(A4) According to some implementations of any of the methods of A1-A3, the targeted context information is reassessed on a per-query basis over a course of the dialogue in which plural different topics are explored, and when processing a particular input query pertaining to a particular topic, the selecting chooses only parts of the candidate context information that pertain to the particular topic.

(A5) According to some implementations of any of the methods of A1-A4, the input query references a document, and wherein the selecting identifies at least one part of the document that is related to the input query.

(A6) According to some implementations of any of the methods of A1-A5, the method further includes: assessing a complexity level associated with a task of processing the input query; and determining a size of the prompt information based on the complexity level. The method uses the size of the prompt information to govern an amount of the candidate content information that the selecting incorporates into the prompt information.

(A7) According to some implementations of the method of A6, the assessing is based on an explicit instruction received by the method, the instruction specifying a complexity level for an entirety of the dialogue or a particular dialogue turn in the dialogue.

(A8) According to some implementations of the methods of A6 or A7, the assessing is based on a determination of resource capabilities of an execution platform that implements the language model, and/or a number of queued requests at the execution platform.

(A9) According to some implementations of any of the methods of A6-A8, the assessing is performed by rules-based logic or a machine-trained model based on a determination of a complexity of the input query, the complexity being assessed based on a length of the input query, or a number of clauses in the input query, or a complexity of logical relations expressed in the input query, or a number of named entities in the input query, or a complexity of the dialogue, or any combination thereof.

(A10) According to some implementations of any of the methods of A1-A9, the dialogue history is partitioned into dialogue parts, and wherein the selecting includes: mapping the input query to a query embedding; mapping the dialogue parts to respective dialogue-part embeddings using a neural network; assessing distance in a vector space between the query embedding and a dialogue-part embedding associated with a particular dialogue part; identifying the particular dialogue part as relevant to the current query upon determining that the distance satisfies a prescribed relevance test; and including the particular dialogue part in the prompt information upon determining that the particular dialogue part is relevant.

(A11) According to some implementations of any of the methods of A1-A10, the body of candidate context information also includes knowledge information retrieved from at least one knowledge source other than the dialogue history based on the input query or a previous input query in the dialogue.

(A12) According to some implementations of the method of A11, the knowledge information is partitioned into knowledge items, and wherein the selecting also includes: mapping the input query to a query embedding; mapping the knowledge items to respective knowledge-item embeddings using a neural network; assessing distance in vector space between the query embedding and a knowledge-item embedding associated with a particular knowledge item; identifying the particular knowledge item as relevant to the current query upon determining that the distance satisfies a prescribed relevance test; and including the particular knowledge item in the prompt information upon determining that the particular dialogue part is relevant.

(A13) According to some implementations of any of the methods of A1-A12, the parts produced by the partitioning correspond to individual input queries and responses in the dialogue, or parts thereof.

(A14) According to some implementations of any of the methods of A1-A13, the partitioning is performed for each dialogue turn in the dialogue based on a complexity level of a particular input query associated with each dialogue turn.

In yet another aspect, some implementations of the technology described herein include a computing system (e.g., the computing system 1802) that includes a processing system (e.g., the processing system 1804) having a processor. The computing system also includes a storage device (e.g., the computer-readable storage media 1806) for storing computer-readable instructions (e.g., information 1808). The processing system executes the computer-readable instructions to perform any of the methods described herein (e.g., any individual method of the methods of A1-A14).

In yet another aspect, some implementations of the technology described herein include a computer-readable storage medium (e.g., the computer-readable storage media 1806) for storing computer-readable instructions (e.g., the information 1808). A processing system (e.g., the processing system 1804) executes the computer-readable instructions to perform any of the operations described herein (e.g., the operation in any individual method of the methods of A1-A14).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

As to terminology used in this description, the phrase “configured to” encompasses various physical and tangible mechanisms for performing an identified operation. The mechanisms are configurable to perform an operation using the hardware logic circuitry 1812 of FIG. 18. The term “logic” likewise encompasses various physical and tangible mechanisms for performing a task. For instance, each processing-related operation illustrated in the flowcharts of FIGS. 15 and 16 corresponds to a logic component for performing that operation.

This description may have identified one or more features as optional. This type of statement is not to be interpreted as an exhaustive indication of features that are to be considered optional; generally, any feature is to be considered as an example, although not explicitly identified in the text, unless otherwise noted. Further, any mention of a single entity is not intended to preclude the use of plural such entities; similarly, a description of plural entities in the specification is not intended to preclude the use of a single entity. As such, a statement that an apparatus or method has a feature X does not preclude the possibility that it has additional features. Further, any features described as alternative ways of carrying out identified functions or implementing identified mechanisms are also combinable together in any combination, unless otherwise noted.

In terms of specific terminology, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for interacting with a machine-trained language model, comprising:
receiving an input query;
accessing a state data store that provides candidate context information, the candidate context information including a dialogue history that precedes the input query, the dialogue history including previous input queries submitted to the language model, and previous responses generated by the language model for the previous input queries;
partitioning the candidate context information into plural parts, each part including one or more content units;
selecting targeted context information from the candidate context information by determining a semantic relevance of the input query to each of the plural parts by performing vector-based analysis;
creating prompt information that includes the input query and the targeted context information, the selecting reducing a size of the prompt information by selecting a subset of the parts of the candidate context information that is less than all of the parts of the candidate context information;
submitting the prompt information to the machine-trained language model, and receiving a response from the machine-trained language model based on the prompt information; and
generating output information based on the response,
the receiving, accessing, partitioning, selecting, creating, submitting, and generating being repeated for each turn of a dialogue.

2. The method of claim 1, wherein a content unit is a word or a part of a word.

3. The method of claim 1, wherein the machine-trained language model is a transformer-based model that includes attention logic for assessing relevance to be given to a part of input information fed to the attention logic when interpreting each part of the input information.

4. The method of claim 1, wherein the targeted context information is reassessed on a per-query basis over a course of the dialogue in which plural different topics are explored, and wherein, when processing a particular input query pertaining to a particular topic, the selecting chooses only parts of the candidate context information that pertain to the particular topic.

5. The method of claim 1, wherein the input query references a document, and wherein the selecting identifies at least one part of the document that is related to the input query.

6. The method of claim 1, wherein the method further includes:
assessing a complexity level associated with a task of processing the input query; and
determining a size of the prompt information based on the complexity level,
the method using the size of the prompt information to govern an amount of the candidate content information that the selecting incorporates into the prompt information.

7. The method of claim 6, wherein the assessing is based on an explicit instruction received by the method, the instruction specifying a complexity level for an entirety of the dialogue or a particular dialogue turn in the dialogue.

8. The method of claim 6, wherein the assessing is based on a determination of resource capabilities of an execution platform that implements the language model, and/or a number of queued requests at the execution platform.

9. The method of claim 6, wherein the assessing is performed by rules-based logic or a machine-trained model based on a determination of a complexity of the input query, the complexity being assessed based on a length of the input query, or a number of clauses in the input query, or a complexity of logical relations expressed in the input query, or a number of named entities in the input query, or a complexity of the dialogue, or any combination thereof.

10. The method of claim 1, wherein the dialogue history is partitioned into dialogue parts, and wherein the selecting includes:
mapping the input query to a query embedding;
mapping the dialogue parts to respective dialogue-part embeddings using a neural network;
assessing distance in a vector space between the query embedding and a dialogue-part embedding associated with a particular dialogue part;
identifying the particular dialogue part as relevant to the current query upon determining that the distance satisfies a prescribed relevance test; and
including the particular dialogue part in the prompt information upon determining that the particular dialogue part is relevant.

11. The method of claim 1, wherein the candidate context information also includes knowledge information retrieved from at least one knowledge source other than the dialogue history based on the input query or a previous input query in the dialogue.

12. The method of claim 11, wherein the knowledge information is partitioned into knowledge items, and wherein the selecting also includes:
mapping the input query to a query embedding;
mapping the knowledge items to respective knowledge-item embeddings using a neural network;
assessing distance in vector space between the query embedding and a knowledge-item embedding associated with a particular knowledge item;
identifying the particular knowledge item as relevant to the current query upon determining that the distance satisfies a prescribed relevance test; and
including the particular knowledge item in the prompt information upon determining that the particular dialogue part is relevant.

13. The method of claim 1, wherein the parts produced by the partitioning correspond to individual input queries and responses in the dialogue, or parts thereof.

14. The method of claim 1, wherein the partitioning is performed for each dialogue turn in the dialogue based on a complexity level of a particular input query associated with each dialogue turn.

15. A computing system for interacting with a machine-trained language model, comprising:
an instruction data store for storing computer-readable instructions;
a state data store for storing candidate context information, the candidate context information including a dialogue history that precedes the input query, the dialogue history including previous input queries submitted to the language model, and previous responses generated by the language model for the previous input queries; and
a processing system for executing the computer-readable instructions in the instruction data store based on the candidate context information in the state data store, to perform operations including:
receiving an input query;
accessing the state data store that provides candidate context information;
partitioning the candidate context information into plural parts, each part including one or more content units;
selecting targeted context information from the candidate context information by determining a semantic relevance of the input query to each of the plural parts by performing vector-based analysis;
creating prompt information that includes the input query and the targeted context information, the selecting reducing a size of the prompt information by selecting a subset of the parts of the candidate context information that is less than all of the parts of the candidate context information;
submitting the prompt information to the machine-trained language model, and receiving a response from the machine-trained language model based on the prompt information; and
generating output information based on the response,
the receiving, accessing, partitioning, selecting, creating, submitting, and generating being repeated for each turn of a dialogue.

16. The computing system of claim 15, wherein the targeted context information is recomputed on a per-query basis over a course of the dialogue in which plural different topics are explored, and wherein, when processing a particular input query pertaining to a particular topic, the selecting chooses only parts of the candidate context information that pertain to the particular topic.

17. The computing system of claim 15, wherein the operations further include:
assessing a complexity level associated with a task of processing the input query;
determining a size of the prompt information based on the complexity level; and
using the size of the prompt information to govern an amount of the candidate content information that the selecting incorporates into the prompt information,
wherein the assessing is based on:
an explicit instruction that has been received, the instruction specifying a complexity level for an entirety of the dialogue or a particular dialogue turn in the dialogue; and/or
a determination of resource capabilities of an execution platform that implements the language model, and/or a number of queued requests at the execution platform;
and/or a determination of a complexity of the input query made by rules-based logic and/or a machine-trained model.

18. The computing system of claim 15, wherein the dialogue history is partitioned into dialogue parts, and wherein the selecting includes:
mapping the input query to a query embedding;
mapping the dialogue parts to respective dialogue-part embeddings using a neural network;
assessing distance in a vector space between the query embedding and a dialogue-part embedding associated with a particular dialogue part;
identifying the particular dialogue part as relevant to the current query upon determining that the distance satisfies a prescribed relevance test; and
including the particular dialogue part in the prompt information upon determining that the particular dialogue part is relevant.

19. The computing system of claim 15, wherein the candidate context information also includes knowledge information retrieved from at least one knowledge source other than the dialogue history based on the input query or a previous input query in the dialogue,
wherein the knowledge information is partitioned into knowledge items, and wherein the selecting also includes:
mapping the input query to a query embedding;
mapping the knowledge items to respective knowledge-item embeddings using a neural network;
assessing distance in vector space between the query embedding and a knowledge-item embedding associated with a particular knowledge item;
identifying the particular knowledge item as relevant to the current query upon determining that the distance satisfies a prescribed relevance test; and
including the particular knowledge item in the prompt information upon determining that the particular dialogue part is relevant.

20. A computer-readable storage medium for storing computer-readable instructions, a processing system executing the computer-readable instructions to perform operations, the operations comprising:
receiving an input query;
accessing a state data store that provides candidate context information, the candidate context information including a dialogue history that precedes the input query, the dialogue history including previous input queries submitted to the language model, and previous responses generated by the language model for the previous input queries,
the candidate context information also including knowledge information retrieved from at least one knowledge source other than the dialogue history based on the input query or a previous input query;
partitioning the candidate context information into plural parts, each part including one or more content units;
selecting targeted context information from the candidate context information by determining a semantic relevance of the input query to each of the plural parts by performing vector-based analysis;
creating prompt information that includes the input query and the targeted context information, the selecting reducing a size of the prompt information by selecting a subset of the parts of the candidate context information that is less than all of the parts of the candidate context information;
submitting the prompt information to a machine-trained language model, and receiving a response from the machine-trained language model based on the prompt information; and
generating output information based on the response,
the receiving, accessing, partitioning, selecting, creating, submitting, and generating being repeated for each turn of a dialogue.
